(19) United States
(12) Patent Application Publication
(10) Pub. No.: US 2020/0005806 A1
(43) Pub. Date: Jan. 2, 2020

(54) CALL QUALITY IMPROVEMENT SYSTEM, APPARATUS AND METHOD

(71) Applicant: LG Electronics Inc., Seoul (KR)

(72) Inventors: Jae Pil SEO, Seoul (KR); Keun Sang LEE, Seoul (KR); Hyeon Sik CHOI, Incheon (KR)

(21) Appl. No.: 16/564,884

(22) Filed: Sep. 9, 2019

(30) Foreign Application Priority Data
Aug. 22, 2019 (KR) 10-2019-0103031

(51) Int. Cl. G10L 21/0216; G06K 9/00; H04M 9/08; H04B 17/336

(52) U.S. Cl. CPC G10L 21/0216; G06K 9/00335; G10L 2021/02082; H04M 9/082; H04B 17/336; H04M 9/085

(57) ABSTRACT

Provided is a call quality improvement method configured to operate a call quality improvement system and a call quality improvement apparatus by executing an artificial intelligence (AI) algorithm and/or a machine learning algorithm in a 5G environment connected for the Internet of Things. According to one embodiment of the present disclosure, the call quality improvement method may include receiving a voice signal from a far-end speaker, receiving a sound signal including a voice signal from a near-end speaker, receiving an image of a face of the near-end speaker, including lips, and extracting the voice signal of the near-end speaker from the received sound signal.

### CROSS-REFERENCE TO RELATED APPLICATION

This application claims benefit of priority to Korean Patent Application No. 10-2019-0103031, filed on Aug. 22, 2019, the entire disclosure of which is incorporated herein by reference.

### BACKGROUND

### 1. Technical Field

The present disclosure relates to a call quality improvement system, apparatus, and method, and more particularly, to a call quality improvement system, apparatus, and method, which are capable of improving call quality by performing echo cancellation and noise reduction based on lip-reading.

### 2. Description of Related Art

Due to recent development of electronic devices, many parts depend on the control of electronic devices to improve the performance of automobiles. The development of such electronic devices has been applied to safety devices for securing safety of drivers, or to various additional devices and driving devices for providing the driver's convenience. In particular, as mobile phones are becoming more common and calls are frequently made while driving, hands-free devices are essentially installed in vehicles. Various technologies for improving the performance of the hands-free devices have been developed. In particular, echo cancellation and noise reduction (EC/NR) technology is a key technology element in the hands-free call scene within the vehicle. Without this technology, echo and in-vehicle noise (driving noise, wind noise, or the like) may be mixed in a voice signal of a driver (near-end speaker) during a call, which may cause a significant discomfort to a call partner (far-end speaker).

Korean Patent Application Publication No. 10-2014-0044708, published Apr. 15, 2014 (hereinafter referred to as “Related Art 1”), discloses a technology relating to a noise reduction method of a vehicle hands-free, which processes noise with respect to a voice signal inputted through the vehicle hands-free in consideration of a current driving speed of the vehicle, thereby providing optimal call quality in each situation, such as a stop situation, low speed driving, and high speed driving.

In addition, Korean Patent Application Publication No. 10-2017-0044393, published Apr. 25, 2017 (hereinafter referred to as “Related Art 2”), discloses a technology relating to a vehicle hands-free control method which modulates a received first voice signal and removes an echo component from an inputted second voice signal based on the modulated first voice signal, thereby improving correlated echoes and double talk performance.

That is, Related Art 1 and Related Art 2 can improve call quality by performing adaptive noise processing and echo component removal on the voice signal inputted through the hands-free. However, Related Art 1 and Related Art 2 perform noise processing and echo component removal based on a signal inputted through a microphone. Thus, contrary to theory, the performance is very poor in a vehicle environment in which actual wind noise and driving noise are severe. Also, if the noise cancellation intensity is increased so as to cancel noise coming into the microphone that is louder than the speech of the driver, the speech of the driver may be severely distorted, resulting in a significant deterioration in call quality.

The above-described background technology is technical information that the inventors hold for the derivation of the present disclosure or that the inventors acquired in the process of deriving the present disclosure. Thus, the above-described background technology cannot be regarded as known technology disclosed to the general public prior to the filing of the present application.

### SUMMARY OF THE INVENTION

An aspect of the present disclosure is to improve call quality by performing echo cancellation and noise reduction (EC/NR) based on lip-reading.

Another aspect of the present disclosure is to improve the accuracy and performance of echo cancellation and noise reduction by applying a lip-reading technique using image information to an echo cancellation and noise reduction technique.

Still another aspect of the present disclosure is to apply lip-reading to accurately determine the states of four cases according to the presence or absence of speech of a near-end speaker (driver) and the presence or absence of speech of a far-end speaker (call partner), thereby improving the echo cancellation performance by applying appropriate parameters depending on the situation.

Yet another aspect of the present disclosure is to reconstruct a voice signal of a near-end speaker, which is damaged due to excessive noise cancellation, through accurate harmonic estimation of the near-end speaker, thereby improving the performance of a call quality improvement apparatus.

Still another aspect of the present disclosure is to estimate the presence or absence of speech of a near-end speaker and a voice signal based on the speech according to a change in the positions of feature points of the near-end speaker's lips by using a pre-trained neural network model for lip-reading, thereby improving the reliability of a call quality improvement system.

Yet another aspect of the present disclosure is to estimate noise information generated inside a vehicle according to a vehicle model by using a pre-trained neural network model for noise estimation, thereby improving the reliability of a call quality improvement system.

The present disclosure is not limited to what has been described above, and other aspects not mentioned herein will be apparent from the following description to one of ordinary skill in the art to which the present disclosure pertains. Furthermore, it will be understood that aspects and advantages of the present disclosure may be achieved by the means set forth in claims and combinations thereof.

A call quality improvement method according to an embodiment of the present disclosure may include performing control such that call quality is improved by performing echo cancellation and noise reduction based on lip-reading.

A call quality improvement system using lip-reading according to another embodiment of the present disclosure may include: a microphone configured to collect a sound signal including a voice signal of a near-end speaker; a speaker configured to output a voice signal from a far-end speaker; a camera configured to photograph a face of the near-end speaker, including lips; and a sound processor configured to extract the voice signal of the near-end speaker from the sound signal collected from the microphone. Here, the sound processor may include an echo reduction module including an adaptive filter configured to filter out an echo component from the sound signal collected through the microphone based on a signal inputted to the speaker, and a filter controller configured to control the adaptive filter. The filter controller may change parameters of the adaptive filter based on lip movement information of the near-end speaker.

In this embodiment of the present disclosure, the call quality improvement system may improve call quality by performing echo cancellation and noise reduction (EC/NR) based on the lip-reading, thereby providing improved call quality to the far-end speaker (call partner).

In this embodiment of the present disclosure, the sound processor may further include a noise reduction module configured to reduce a noise signal in the sound signal from the echo reduction module, and a voice reconstructor configured to reconstruct the voice signal of the near-end speaker damaged during a noise reduction process through the noise reduction module, based on the lip movement information of the near-end speaker.

In this embodiment of the present disclosure, the call quality improvement system may further include a lip-reading module configured to read a lip movement of the near-end speaker based on an image captured by the camera, in which the lip-reading module generates a signal about the presence or absence of speech of the near-end speaker by determining that the speech of the near-end speaker exists when a lip movement of the near-end speaker is equal to or greater than a first size, and determining that the speech of the near-end speaker does not exist when the lip movement of the near-end speaker is less than a second size, and the second size is a value less than or equal to the first size.

In this embodiment of the present disclosure, when the lip movement of the near-end speaker is less than the first size and greater than or equal to the second size, the lip-reading module may determine the presence or absence of the speech of the near-end speaker based on a signal-to-noise ratio (SNR) value estimated for the sound signal.

In this embodiment of the present disclosure, the lip-reading technique using the image information may be applied to the echo cancellation and noise reduction technique through the sound processor and the lip-reading module, thereby improving the accuracy of the echo cancellation and noise reduction and improving the performance of the echo cancellation and noise reduction.

In this embodiment of the present disclosure, based on the signal about the presence or absence of the speech of the near-end speaker from the lip-reading module and the signal inputted to the speaker, the filter controller may be configured to control a parameter value of the adaptive filter to be a first value when only the near-end speaker utters speech, control the parameter value of the adaptive filter to be a second value when only the far-end speaker utters speech, control the parameter value of the adaptive filter to be a third value when both the near-end speaker and the far-end speaker utter speech, and control the parameter value of the adaptive filter to be a fourth value when both the near-end speaker and the far-end speaker do not utter speech.

In this embodiment of the present disclosure, since the filter controller can apply lip-reading to accurately determine the states of four cases according to the presence or absence of the speech of the near-end speaker (driver) and the presence or absence of the speech of the far-end speaker (call partner), the echo cancellation performance may be improved by applying appropriate parameters depending on the situation.

In this embodiment of the present disclosure, the voice reconstructor may extract pitch information of the near-end speaker from the sound signal when only the near-end speaker utters speech, determine speech features of the near-end speaker based on the pitch information, and reconstruct the voice signal of the near-end speaker damaged during a noise reduction process through the noise reduction module, based on the speech features.

In this embodiment of the present disclosure, the voice reconstructor may reconstruct the voice signal of the near-end speaker, which is damaged by excessive noise reduction, through accurate harmonic estimation of the near-end speaker, thereby improving the performance of the call quality improvement apparatus.

In this embodiment of the present disclosure, the call quality improvement system may further include a lip-reading module configured to read a lip movement of the near-end speaker based on an image captured by the camera, in which the lip-reading module estimates the presence or absence of the speech of the near-end speaker and the voice signal according to the speech based on the captured image by using a neural network model for lip-reading pre-trained to estimate the presence or absence of speech of a person and a voice signal based on the speech according to a change in locations of feature points of lips of the person.

In this embodiment of the present disclosure, the call quality improvement system may estimate the presence or absence of the speech of the near-end speaker and the voice signal based on the speech according to the change in the locations of the feature points of the lips of the near-end speaker by using the pre-trained neural network model for lip-reading, thereby improving the reliability of the call quality improvement system.

In this embodiment of the present disclosure, the sound processor may extract the voice signal of the near-end speaker from the sound signal collected from the microphone, based on the presence or absence of the speech of the near-end speaker estimated from the lip-reading module and the voice signal based on the speech.

In this embodiment of the present disclosure, the sound processor may enable rapid data processing by performing echo cancellation and noise reduction during a hands-free call within the vehicle through 5G network-based communication, thereby further improving the performance of the call quality improvement system.

In this embodiment of the present disclosure, the call quality improvement system may be disposed in a vehicle, may include a driving noise estimator configured to receive driving information of the vehicle and estimate noise information generated in the vehicle according to a driving operation, and the noise reduction module may be configured to reduce the noise signal in the sound signal from the echo reduction module based on the noise information estimated by the driving noise estimator.

In this embodiment of the present disclosure, the driving noise estimator may estimate the noise information generated in the vehicle according to the driving operation of the vehicle by using a neural network model for noise estimation pre-trained to estimate noise generated in a vehicle during a vehicle driving operation according to a model of the vehicle.

In this embodiment of the present disclosure, the driving noise estimator may estimate noise information generated in the vehicle according to the model of the vehicle by using the trained neural network model for noise estimation, thereby improving the reliability of the call quality improvement system.

According to another embodiment of the present disclosure, a call quality improvement apparatus may include: a call receiver configured to receive a voice signal from a far-end speaker; a sound input module configured to receive a sound signal including a voice signal from a near-end speaker; an image receiver configured to receive an image of a face of the near-end speaker, including lips; and a sound processor configured to extract the voice signal of the near-end speaker from the sound signal collected through the sound input module. Here, the sound processor may include an adaptive filter configured to filter out an echo component in the sound signal based on the voice signal received by the call receiver, and parameters of the adaptive filter may be changed based on lip movement information of the near-end speaker.

In this embodiment of the present disclosure, the sound processor may further include a noise reduction module configured to reduce a noise signal in the sound signal from the echo reduction module, and a voice reconstructor configured to reconstruct the voice signal of the near-end speaker damaged during a noise reduction process through the noise reduction module, based on the lip movement information of the near-end speaker.

In this embodiment of the present disclosure, since the call quality improvement apparatus can improve call quality by performing echo cancellation and noise reduction (EC/NR) based on lip-reading using image information, the performance of the echo cancellation and noise reduction may be improved, thereby providing improved call quality to the far-end speaker (call partner).

In the embodiment of the present disclosure, the call quality improvement apparatus may further include a lip-reading module configured to read a lip movement of the near-end speaker based on the image received from the image receiver, in which the lip-reading module generates a signal about the presence or absence of speech of the near-end speaker by determining that the speech of the near-end speaker exists when a lip movement of the near-end speaker is equal to or greater than a first size, and determining that the speech of the near-end speaker does not exist when the lip movement of the near-end speaker is less than a second size, and the second size is a value less than or equal to the first size.

In this embodiment of the present disclosure, when the lip movement of the near-end speaker is less than the first size and greater than or equal to the second size, the lip-reading module determines the presence or absence of the speech of the near-end speaker based on a signal-to-noise ratio (SNR) value estimated for the sound signal.

In this embodiment of the present disclosure, the parameters of the adaptive filter may be determined based on the signal about the presence or absence of the speech of the near-end speaker from the lip-reading module and the voice signal received by the call receiver.

In this embodiment of the present disclosure, the lip-reading module may apply lip-reading to accurately determine the states of four cases according to the presence or absence of speech of the near-end speaker (driver) and the presence or absence of speech of the far-end speaker (call partner), thereby improving the echo cancellation performance by applying appropriate parameters depending on the situation.

In this embodiment of the present disclosure, the voice reconstructor may determine a case where only the near-end speaker utters speech, based on the signal about the presence or absence of the speech of the near-end speaker from the lip-reading module and the voice signal received by the call receiver, extract pitch information of the near-end speaker from the sound signal uttered by only the near-end speaker, determine speech features of the near-end speaker based on the pitch information, and reconstruct the voice signal of the near-end speaker damaged in a noise reduction process through the noise reduction module based on the speech features.

In this embodiment of the present disclosure, the voice reconstructor may reconstruct the voice signal of the near-end speaker, which is damaged due to excessive noise cancellation, through accurate harmonic estimation of the near-end speaker, thereby improving the performance of a call quality improvement apparatus.

According to another aspect of the present disclosure, a call quality improvement method may include: receiving a voice signal from a far-end speaker; receiving a sound signal including a voice signal from a near-end speaker; receiving an image of a face of the near-end speaker, including lips; and extracting the voice signal of the near-end speaker from the received sound signal. Here, the extracting of the voice signal may include determining a parameter value of an adaptive filter according to a lip movement of the near-end speaker, and filtering out an echo component from the sound signal using the adaptive filter based on the voice signal from the far-end speaker.

According to this embodiment, since the call quality improvement method can improve call quality by performing echo cancellation and noise reduction (EC/NR) based on lip-reading using image information, the performance of the echo cancellation and noise reduction may be improved, thereby providing improved call quality to the far-end speaker (call partner).

In this embodiment of the present disclosure, the extracting of the voice signal may include reducing a noise signal in the sound signal outputted from the filtering, and reconstructing the voice signal of the near-end speaker damaged in the reducing of the noise signal, based on a sound signal when the far-end speaker does not utter speech and the near-end speaker utters speech.

In this embodiment of the present disclosure, the extracting of the voice signal may apply lip-reading to accurately determine the states of four cases according to the presence or absence of speech of the near-end speaker (driver) and the presence or absence of speech of the far-end speaker (call partner), thereby improving the echo cancellation performance by applying appropriate parameters depending on the situation.

In this embodiment of the present disclosure, the call quality improvement method may further include, after the receiving of the image, reading a lip movement of the near-end speaker based on the received image. Here, the reading may include generating a signal about the presence or absence of speech of the near-end speaker by determining that the speech of the near-end speaker exists when the lip movement of the near-end speaker is equal to or greater than a first size, and determining that the speech of the near-end speaker does not exist when the lip movement of the near-end speaker is less than a second size.

In this embodiment of the present disclosure, the call quality improvement method may estimate the presence or absence of the speech of the near-end speaker and the voice signal based on the speech according to the change in the locations of the feature points of the lips of the near-end speaker by using the pre-trained neural network model for lip-reading, thereby improving the reliability of the call quality improvement system.

In this embodiment of the present disclosure, the reconstructing of the voice signal of the near-end speaker may include extracting pitch information of the near-end speaker from a sound signal when only the near-end speaker utters speech, determining speech features of the near-end speaker based on the pitch information, and reconstructing the voice signal of the near-end speaker damaged in the reducing of the noise signal based on the speech features.

In this embodiment of the present disclosure, the reconstructing of the voice signal of the near-end speaker may reconstruct the voice signal of the near-end speaker, which is damaged by excessive noise reduction, through accurate harmonic estimation of the near-end speaker, thereby improving the performance of the call quality improvement apparatus.

In addition, in order to implement the present disclosure, there may be further provided other methods, other systems, and a computer-readable recording medium having a computer program stored thereon to execute the methods.

Other aspects, features, and advantages other than those described above will become apparent from the following drawings, claims, and detailed description of the present disclosure.

According to embodiments of the present disclosure, call quality may be improved by performing echo cancellation and noise reduction (EC/NR) based on lip-reading, thereby providing improved call quality to the far-end speaker (call partner).

In addition, the accuracy and performance of echo cancellation and noise reduction may be improved by applying the lip-reading technique using image information to the echo cancellation and noise reduction technique.

In addition, lip-reading may be applied to accurately determine the states of four cases according to the presence or absence of speech of the near-end speaker (driver) and the presence or absence of speech of the far-end speaker (call partner), thereby improving the echo cancellation performance by applying appropriate parameters depending on the situation.

In addition, the voice signal of the near-end speaker, which is damaged due to excessive noise cancellation, may be reconstructed through accurate harmonic estimation of the near-end speaker, thereby improving the performance of the call quality improvement apparatus.

In addition, the presence or absence of speech of the near-end speaker and the voice signal based on the speech according to a change in the positions of feature points of the near-end speaker's lips are estimated by using the pre-trained neural network model for lip-reading, thereby improving the reliability of the call quality improvement system.

In addition, noise information generated inside the vehicle according to the vehicle model may be estimated by using the pre-trained neural network model for noise estimation, thereby improving the reliability of a call quality improvement system.

In addition, rapid data processing may be enabled by performing echo cancellation and noise reduction during a hands-free call within the vehicle through 5G network-based communication, thereby further improving the performance of the call quality improvement system.

In addition, although the call quality improvement apparatus itself is a mass-produced uniform product, the user recognizes the call quality improvement apparatus as a personalized device, thereby exhibiting the effect of a user-customized product.

The effects of the present disclosure are not limited to the effects mentioned above, and other effects not mentioned may be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary view of an artificial intelligence (AI) system-based call quality improvement system environment including an AI server, a self-driving vehicle, a robot, an extended reality (XR) device, a smartphone or a home appliance, and a cloud network connecting one or more of these components to each other, according to an embodiment of the present disclosure;

FIG. 2 is a diagram schematically illustrating a communication environment of a call quality improvement system according to an embodiment of the present disclosure;

FIG. 3 is a schematic block diagram of a self-driving vehicle according to an embodiment of the present disclosure;

FIG. 4 illustrates an example of basic operations of a self-driving vehicle and a 5G network in a 5G communication system;

FIG. 5 illustrates an example of application operations of a self-driving vehicle and a 5G network in a 5G communication system;

FIGS. 6 to 9 illustrate an example of an operation of a self-driving vehicle using 5G communication;

FIG. 10 is an exemplary view for describing a call quality improvement system according to an embodiment of the present disclosure;

FIG. 11 is a schematic block diagram for describing a learning method of a call quality improvement system according to an embodiment of the present disclosure;

FIG. 12 is a schematic block diagram of a call quality improvement system according to an embodiment of the present disclosure;

FIG. 13 is a block diagram for describing a call quality improvement system in detail according to an embodiment of the present disclosure;

FIGS. 14A to 14C are exemplary views for describing a lip movement reading method of a call quality improvement system according to an embodiment of the present disclosure;

FIG. 15 is a schematic diagram for describing a voice reconstruction method of a call quality improvement system according to an embodiment of the present disclosure;

FIG. 16 is a flowchart of a call quality improvement method according to an embodiment of the present disclosure; and

FIG. 17 is a flowchart for describing a voice signal extraction method of a call quality improvement system according to an embodiment of the present disclosure.

### DETAILED DESCRIPTION

Advantages and features of the present disclosure and methods for achieving them will become apparent from the descriptions of aspects hereinbelow with reference to the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In relation to describing the present disclosure, when the detailed description of the relevant known technology is determined to unnecessarily obscure the gist of the present disclosure, the detailed description may be omitted.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

A vehicle described in the present specification may refer to a car, an automobile, and a motorcycle. Hereinafter, the vehicle will be exemplified as an automobile.

The vehicle described in the present specification may include, but is not limited to, a vehicle having an internal combustion engine as a power source, a hybrid vehicle having an engine and an electric motor as a power source, and an electric vehicle having an electric motor as a power source.

Hereinafter, embodiments of the present disclosure will be described in detail with reference to the accompanying drawings. Like reference numerals designate like elements throughout the specification, and overlapping descriptions of the elements will not be provided.

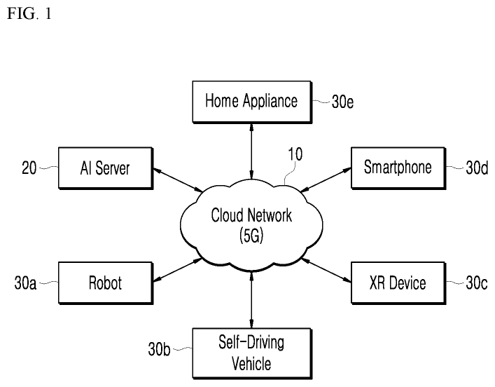

FIG. 1 is an exemplary view of an AI system-based call quality improvement system environment including an AI server, a self-driving vehicle, a robot, an XR device, a smartphone or a home appliance, and a cloud network connecting one or more of these components to each other, according to an embodiment of the present disclosure.

Referring to FIG. 1, the AI system-based call quality improvement system environment may include an AI server 20, a robot 30a, a self-driving vehicle 30b, an XR device 30c, a smartphone 30d or a home appliance 30e, and a cloud network 10. In this case, in the AI system-based call quality improvement system environment, at least one among the AI server 20, the robot 30a, the self-driving vehicle 30b, the XR device 30c, the smartphone 30d, and the home appliance 30e is connected to the cloud network 10. Here, the robot 30a, the self-driving vehicle 30b, the XR device 30c, the smartphone 30d, or the home appliance 30e, to which AI technology is applied, may be referred to as AI devices 30a to 30e.

The robot 30a may refer to a machine which automatically handles a given task by its own ability, or which operates autonomously. In particular, a robot having a function of recognizing an environment and performing an operation according to its own determination may be referred to as an intelligent robot. The robot 30a may be classified into industrial, medical, household, and military robots, according to the purpose or field of use. The robot 30a may include an actuator or a driver including a motor in order to perform various physical operations, such as moving joints of the robot. Moreover, a movable robot may include, for example, a wheel, a brake, and a propeller in the driver thereof, and through the driver may thus be capable of traveling on the ground or flying in the air.

The self-driving vehicle 30b refers to a vehicle which travels without the user's manipulation or with minimal manipulation of the user, and may also be referred to as an autonomous-driving vehicle. For example, autonomous driving may include a technology in which a driving lane is maintained, a technology such as adaptive cruise control in which a speed is automatically adjusted, a technology in which a vehicle automatically drives along a defined route, and a technology in which a route is automatically set when a destination is set. In this case, an autonomous vehicle may be considered as a robot with an autonomous driving function.

The XR device 30c refers to a device using extended reality (XR), which collectively refers to virtual reality (VR), augmented reality (AR), and mixed reality (MR). VR technology provides objects or backgrounds of the real world only in the form of CG images, AR technology provides virtual CG images overlaid on the physical object images, and MR technology employs computer graphics technology to mix and merge virtual objects with the real world. MR technology is similar to AR technology in that both technologies involve physical objects being displayed together with virtual objects. However, while virtual objects supplement physical objects in AR, virtual and physical objects co-exist as equivalents in MR. XR technology may be applied to a head-mounted display (HMD), a head-up display (HUD), a mobile phone, a tablet PC, a laptop computer, a desktop computer, a TV, digital signage, and the like. A device employing XR technology may be referred to as an XR device.

The smartphone 30d may refer to one of user terminals as an example. Such a user terminal may connect to a call quality improvement system operating application or a call quality improvement system operating site and receive a service for operating or controlling the call quality improvement system through an authentication process. In the present embodiment, the user terminal that has completed the authentication process may operate the call quality improvement system 1 and control the operation of the call quality improvement apparatus 11.

In the present embodiment, the user terminal may be a desktop computer, a smartphone, a notebook, a tablet PC, a smart TV, a cell phone, a personal digital assistant (PDA), a laptop, a media player, a micro server, a global positioning system (GPS) device, an electronic book terminal, a digital broadcast terminal, a navigation device, a kiosk, an MP3 player, a digital camera, a home appliance, and other mobile or immobile computing devices operated by the user, but is not limited thereto. Further, the user terminal may be a wearable terminal such as a clock, eyeglasses, a hair band, and a ring having a communication function and a data processing function. The user terminal is not limited to the above-mentioned devices, and thus any terminal that supports web browsing may be adopted.

The home appliance 30e may include any one of all electronic devices provided in a home. In particular, the home appliance 30e may include a terminal capable of implementing voice recognition, artificial intelligence, and the like, and a terminal for outputting at least one of an audio signal and a video signal. In addition, the home appliance 30e may include various home appliances (for example, a washing machine, a drying machine, a clothes processing apparatus, an air conditioner, a kimchi refrigerator, or the like) without being limited to specific electronic devices.

The cloud network 10 may include part of the cloud computing infrastructure or refer to a network existing in the cloud computing infrastructure. Here, the cloud network 10 may be constructed by using the 3G network, 4G or Long Term Evolution (LTE) network, or a 5G network. That is, the respective devices (30a to 30e, 20) constituting the AI system-based call quality improvement system environment may be connected to each other through the cloud network 10. In particular, each individual device (30a to 30e, 20) may communicate with each other through the base station but may communicate directly to each other without relying on the base station.

The cloud network 10 may include, for example, wired networks such as local area networks (LANs), wide area networks (WANs), metropolitan area networks (MANs), and integrated service digital networks (ISDNs), or wireless networks such as wireless LANs, CDMA, Bluetooth, and satellite communication, but the scope of the present disclosure is not limited thereto. Furthermore, the cloud network 10 may transmit and receive information using short-range communications or long-distance communications. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The cloud network 10 may include connection of network elements such as hubs, bridges, routers, switches, and gateways. The cloud network 10 may include one or more connected networks, including a public network such as the Internet and a private network such as a secure corporate private network. For example, the network may include a multi-network environment. The access to the cloud network 10 can be provided via one or more wired or wireless access networks. Furthermore, the cloud network 10 may support 5G communication and/or an Internet of things (IoT) network for exchanging and processing information between distributed components such as objects.

The AI server 20 may include a server performing AI processing and a server performing computations on big data. In addition, the AI server 20 may be a database server that provides big data necessary for applying various AI algorithms and data for operating the call quality improvement system 1. In addition, the AI server 20 may include a web server or an application server for remotely controlling the operation of the vehicle by using the call quality improvement system operating application or the call quality improvement system operating web browser installed on the smartphone 30d.

The AI server 20 may be connected to at least one among the AI devices constituting the AI system-based call quality improvement system environment, that is, the robot 30a, the self-driving vehicle 30b, the XR device 30c, the smartphone 30d, and the home appliance 30e, through the cloud network 10, and may assist at least part of AI processing of the connected AI devices 30a to 30e. At this time, the AI server 20 may train the AI network according to the machine learning algorithm instead of the AI devices 30a to 30e, and may directly store the learning model or transmit the learning model to the AI devices 30a to 30e. At this time, the AI server 20 may receive input data from the AI device 30a to 30e, infer a result value from the received input data by using the learning model, generate a response or control command based on the inferred result value, and transmit the generated response or control command to the AI device 30a to 30e. Similarly, the AI device 30a to 30e may infer a result value from the input data by employing the learning model directly and generate a response or control command based on the inferred result value.

Artificial intelligence (AI) is an area of computer engineering science and information technology that studies methods to make computers mimic intelligent human behaviors such as reasoning, learning, self-improving, and the like.

In addition, artificial intelligence (AI) does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. Specifically, the machine learning can be a technology for researching and constructing a system for learning, predicting, and improving its own performance based on empirical data and an algorithm for the same. Machine learning algorithms, rather than only executing rigidly set static program commands, may take an approach that builds models for deriving predictions and decisions from inputted data.

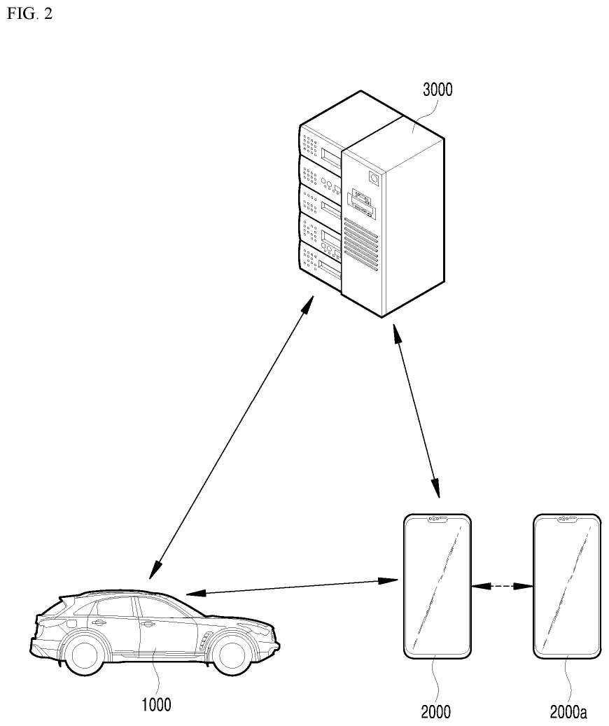

The present embodiment particularly relates to the self-driving vehicle 30b. Thus, among the above-mentioned AI devices to which the technology is applied, the self-driving vehicle 30b will be described in the embodiments below. However, in the present embodiment, the vehicle (1000 of FIG. 2) is not limited to the self-driving vehicle 30b, and may refer to any vehicles, including the self-driving vehicle 30b and general vehicles. Hereinafter, the vehicle in which the call quality improvement system 1 is disposed will be described.

FIG. 2 is a diagram schematically illustrating a communication environment of a call quality improvement system according to an embodiment of the present disclosure. Parts redundant to the description provided with reference to FIG. 1 will be omitted.

Referring to FIG. 2, the call quality improvement system 1 essentially includes a vehicle 1000, a smartphone 2000 of a near-end speaker, for example, a driver, and a smartphone 2000a of a far-end speaker, for example, the call partner, and a server 3000, and may further include components such as a network.

In this case, the near-end speaker may refer to a user who makes a call in the vehicle 1000, and the far-end speaker may refer to a counterpart user who talks to the near-end speaker. For example, the user who makes a call in the vehicle 1000 may be a driver, but is not limited thereto. The user may refer to another user in the vehicle 1000 who communicates through a hands-free function in the vehicle 1000. That is, the smartphone 2000 of the near-end speaker may refer to, for example, a smartphone connected to the vehicle 1000 for an in-vehicle call function such as a hands-free function. In this case, the smartphone 2000 of the near-end speaker may be connected to the vehicle 1000 through short-range wireless communication, and the smartphone 2000a of the far-end speaker may be connected to the smartphone 2000 of the near-end speaker through mobile communication.

In the present embodiment, the server 3000 may include the above-mentioned AI server, a Mobile Edge Computing (MEC) server, or the like. The server 3000 may also collectively refer to the AI server and the MEC server. However, in the present embodiment, the server 3000 illustrated in FIG. 2 may represent an AI server. However, when the server 3000 is another server that is not specified in the present embodiment, the connection relationship illustrated in FIG. 2 may be changed.

The AI server may receive data for improving call quality from the vehicle 1000, may receive near-end speaker information data from the smartphone 2000 of the near-end speaker, and may receive far-end speaker information data from the smartphone 2000a of the far-end speaker. That is, the AI server may perform learning for improving the call quality based on at least one among the data for improving the call quality from the vehicle 1000, the near-end speaker information data, and the far-end speaker information data. The AI server may transmit a learning result for improving the call quality to the vehicle 1000 so that the vehicle 1000 performs the operation for improving the call quality.

The MEC server may act as a general server, and may be connected to a base station (BS) next to a road in a radio access network (RAN) to provide flexible vehicle-related services and efficiently operate the network. In particular, network-slicing and traffic scheduling policies supported by the MEC server can assist the optimization of the network. The MEC server is integrated inside the RAN, and may be located in an S1-user plane interface (for example, between the core network and the base station) in the 3GPP system. The MEC server may be regarded as an independent network element, and does not affect the connection of the existing wireless networks. The independent MEC servers may be connected to the base station via the dedicated communication network and may provide specific services to various end-users located in the cell. These MEC servers and the cloud servers may be connected to each other through an Internet-backbone, and share information with each other. The MEC server may operate independently, and control a plurality of base stations. Services for self-driving vehicles, application operations such as virtual machines (VMs), and operations at the edge side of mobile networks based on a virtualization platform may be performed. The base station (BS) may be connected to both the MEC servers and the core network to enable flexible user traffic scheduling required for performing the provided services.

When a large amount of user traffic occurs in a specific cell, the MEC server may perform task offloading and collaborative processing based on the interface between neighboring base stations.

That is, since the MEC server has an open operating environment based on software, new services of an application provider may be easily provided. Since the MEC server performs the service at a location near the end-user, the data round-trip time is shortened and the service providing speed is high, thereby reducing the service waiting time. MEC applications and virtual network functions (VNFs) may provide flexibility and geographic distribution in service environments. When using this virtualization technology, various applications and network functions can be programmed, and only specific user groups may be selected or compiled for them. Therefore, the provided services may be applied more closely to user requirements. In addition to centralized control ability, the MEC server may minimize interaction between base stations. This may simplify the process for performing basic functions of the network, such as handover between cells. This function may be particularly useful in autonomous driving systems used by a large number of users. In the autonomous driving system, the terminals of the road may periodically generate a large amount of small packets. In the RAN, the MEC server may reduce the amount of traffic that must be delivered to the core network by performing certain services. This may reduce the processing burden of the cloud in a centralized cloud system, may minimize network congestion. The MEC server may integrate network control functions and individual services, which can increase the profitability of Mobile Network Operators (MNOs). Installation density adjustment enables fast and efficient maintenance and upgrades.

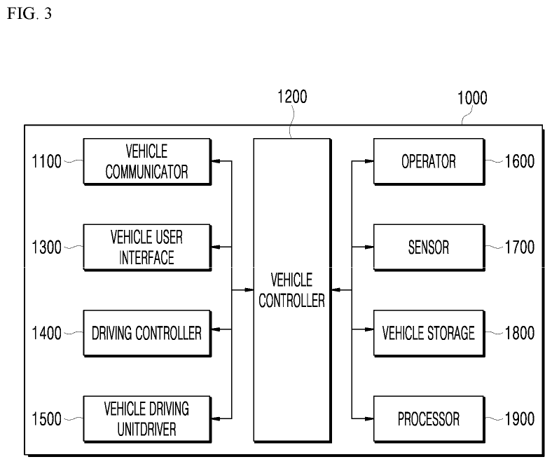

FIG. 3 is a schematic block diagram of a vehicle according to an embodiment of the present disclosure. In the following description, description of parts that are the same as those in FIG. 1 and FIG. 2 will be omitted.

Referring to FIG. 3, the vehicle 1000 in which the call quality improvement system 1 is disposed may include a vehicle communicator 1100, a vehicle controller 1200, a vehicle user interface 1300, a driving controller 1400, a vehicle driver 1500, an operator 1600, a sensor 1700, a vehicle storage 1800, and a processor 1900.

Depending on the embodiment, the vehicle 1000 may include other components in addition to the components illustrated in FIG. 3 and described below, or may not include some of the components illustrated in FIG. 3 and described below.

In the present embodiment, the call quality improvement system 1 may be mounted on the vehicle 1000 including a wheel which rotates by a power source and a steering input device for adjusting a traveling direction. Here, the vehicle 1000 may be a self-driving vehicle, and may be switched from an autonomous driving mode to a manual mode, or switched from the manual mode to the autonomous driving mode according to a user input received through the vehicle user interface 1300. In addition, the vehicle 1000 may be switched from an autonomous mode to a manual mode, or switched from the manual mode to the autonomous mode depending on the driving situation. Here, the driving situation may be determined by at least one among information received by the vehicle communicator 1100, external object information detected by the sensor 1700, and navigation information acquired by a navigation unit (not illustrated).

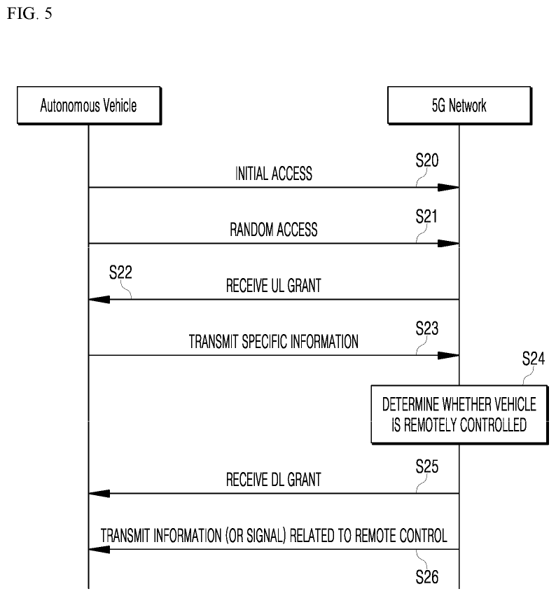

Meanwhile, in the present embodiment, the vehicle 1000 may receive a service request (user input) from the user for control. The method by which the vehicle 1000 receives the service provision request from the user may include the case of receiving a touch (or button input) signal for the vehicle user interface 1300 from the user, the case of receiving the speech corresponding to the service request from the user, and the like. In this case, the touch signal reception, the speech reception, and the like from the user may be possible by the smartphone (30d of FIG. 1). In addition, the speech reception may be provided by a separate microphone which executes a speech recognition function. In this case, the microphone may be the microphone (2 of FIG. 5) of the present embodiment.

When the vehicle 1000 is operated in the autonomous driving mode, the vehicle 1000 may be operated under the control of the operator 1600 that controls driving, parking, and unparking. Meanwhile, when the vehicle 1000 is driven in the manual mode, the vehicle 1000 may be driven by a user input through the driving controller 1400.

The vehicle communicator 1100 may be a module for performing communication with an external device. The vehicle communicator 1100 may support communication in a plurality of communication modes, receive a server signal from the server (3000 of FIG. 2), and transmit a signal to the server. In addition, the vehicle communicator 1100 may receive a signal from another vehicle, transmit a signal to another vehicle, receive a signal from the smartphone, and transmit a signal to the smartphone. That is, the external device may include another vehicle, a smartphone, and a server system. The plurality of communication modes may include a vehicle-to-vehicle communication mode for communicating with other vehicles, a server communication mode for communicating with an external server, a short-range communication mode for communicating with user terminals such as smartphones in vehicles, and the like. That is, the vehicle communicator 1100 may include a wireless communicator (not illustrated), a V2X communicator (not illustrated), and a short-range communicator (not illustrated). The vehicle communicator 1100 may further include a location information unit which receives a signal including location information of the vehicle 1000. The location information unit may include a Global Positioning System (GPS) module or a Differential Global Positioning System (DGPS) module.

The wireless communicator may transmit and receive signals to and from a smartphone or a server through a mobile communication network. Here, the mobile communication network is a multiple access system capable of supporting communication with multiple users by sharing used system resources (bandwidth, transmission power, or the like). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi-carrier frequency division multiple access (MC-FDMA) system. The wireless communicator may transmit specific information to the 5G network when the vehicle 1000 operates in the autonomous driving mode. In this case, the specific information may include autonomous driving-related information. The autonomous driving-related information may be information directly related to driving control of the vehicle. For example, the autonomous driving-related information may include one or more of object data indicating an object around the vehicle, map data, vehicle state data, vehicle location data, and driving plan data. The autonomous driving-related information may further include service information required for autonomous driving. For example, the specific information may include information about the destination and the stability level of the vehicle inputted through the smartphone. The 5G network may determine whether to remotely control the vehicle. Here, the 5G network may include a server or a module which performs remote control related to autonomous driving. The 5G network may transmit information (or a signal) related to the remote control to the autonomous vehicle. As described above, the information related to the remote control may be a signal applied directly to the self-driving vehicle, and may further include service information necessary for autonomous driving.

The V2X communicator may transmit and receive a signal with an RSU through a V2I communication protocol in a wireless manner, may transmit and receive a signal with another vehicle, that is, a vehicle near the vehicle 1000 within a certain distance, through a V2V communication protocol, and may transmit and receive a signal to and from a smartphone, that is, a pedestrian or a user, through a V2P communication protocol. That is, the V2X communicator may include an RF circuit capable of implementing vehicle-to-infrastructure communication (V2I), vehicle-to-vehicle communication (V2V), and vehicle-to-pedestrian communication (V2P). That is, the vehicle communicator 1100 may include at least one among a transmit antenna and a receive antenna for performing communication, and a radio frequency (RF) circuit and an RF element capable of implementing various communication protocols.

The short-range communicator may be connected to the user terminal of the driver through a short-range wireless communication module. In this case, the short-range communicator may be connected to the user terminal through wired communication as well as wireless communication. For example, if the driver's user terminal is registered in advance, the short-range communicator may automatically connect with the vehicle 1000 when the registered user terminal is recognized within a predetermined distance from the vehicle 1000 (for example, in the vehicle). That is, the vehicle communicator 1100 may perform short-range communication, GPS signal reception, V2X communication, optical communication, broadcast transmission and reception, and intelligent transport systems (ITS) communication. The vehicle communicator 1100 may further support other functions than the functions described, or may not support some of the functions described, depending on the embodiment. The vehicle communicator 1100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

Depending on the embodiment, the overall operation of each module of the vehicle communicator 1100 may be controlled by a separate process provided in the vehicle communicator 1100. The vehicle communicator 1100 may include a plurality of processors, or may not include a processor. When a processor is not included in the vehicle communicator 1100, the vehicle communicator 1100 may be operated by either a processor of another apparatus in the vehicle 1000 or the vehicle controller 1200. The vehicle communicator 1100 may, together with the vehicle user interface 1300, implement a vehicle-use display device. In this case, the vehicle display device may be referred to as a telematics device or an audio video navigation (AVN) device.

In the present embodiment, based on a downlink grant of the 5G network connected to operate the vehicle 1000, in which the call quality improvement system 1 is disposed, in the autonomous driving mode, the vehicle communicator 1100 may receive the presence or absence of speech of the near-end speaker and the voice signal information according to the speech based on the image obtained by capturing an arbitrary location (for example, the location of the near-end speaker) in the vehicle by using a neural network model for lip-reading pre-trained to estimate the presence or absence of speech of a person and the voice signal based on the speech according to a change in the positions of the feature points of the person's lips. In addition, based on the downlink grant of the 5G network, the vehicle communicator 1100 may receive noise information generated in the vehicle according to the driving operation of the vehicle 1000 estimated by using the neural network model for noise estimation pre-trained to estimate noise generated in a vehicle during a vehicle driving operation according to the model of the vehicle 1000. In this case, the vehicle communicator 1100 may receive the presence or absence of speech of the near-end speaker and the voice signal information according to the speech, and the noise information generated in the vehicle according to the driving operation of the vehicle 1000 from the AI server connected to the 5G network.

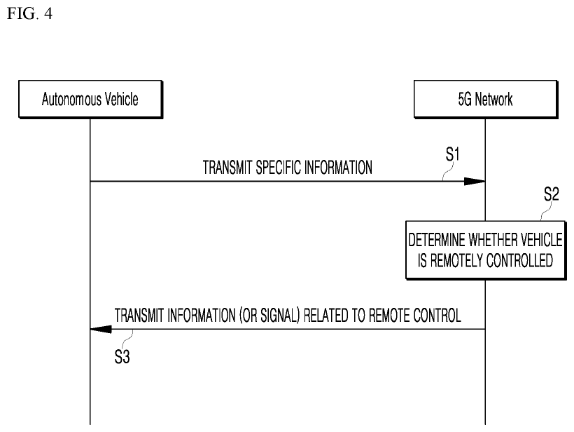

FIG. 4 is a diagram illustrating an example of the basic operation of an autonomous vehicle and a 5G network in a 5G communication system.

The vehicle communicator 1100 may transmit specific information over a 5G network when the vehicle 1000 is operated in the autonomous driving mode.

The specific information may include autonomous driving related information.

The autonomous driving related information may be information directly related to the driving control of the vehicle. For example, the autonomous driving related information may include at least one among object data indicating an object near the vehicle, map data, vehicle status data, vehicle location data, and driving plan data.

The autonomous driving related information may further include service information necessary for autonomous driving. For example, the specific information may include information on a destination inputted through the user terminal 1300 and a safety rating of the vehicle.

In addition, the 5G network may determine whether the vehicle is remotely controlled (S2).

The 5G network may include a server or a module for performing remote control related to autonomous driving.

The 5G network may transmit information (or a signal) related to the remote control to an autonomous vehicle (S3).

As described above, information related to the remote control may be a signal directly applied to the autonomous vehicle, and may further include service information necessary for autonomous driving. The autonomous vehicle according to this embodiment may receive service information such as insurance for each interval selected on a driving route and risk interval information, through a server connected to the 5G network to provide services related to the autonomous driving.

An essential process for performing 5G communication between the autonomous vehicle 1000 and the 5G network (for example, an initial access process between the vehicle and the 5G network) will be briefly described with reference to FIG. 5 to FIG. 9 below.

An example of application operations through the autonomous vehicle 1000 performed in the 5G communication system and the 5G network is as follows.

The vehicle 1000 may perform an initial access process with the 5G network (initial access step, S20). In this case, the initial access procedure includes a cell search process for acquiring downlink (DL) synchronization and a process for acquiring system information.

The vehicle 1000 may perform a random access process with the 5G network (random access step, S21). At this time, the random access procedure includes an uplink (UL) synchronization acquisition process or a preamble transmission process for UL data transmission, a random access response reception process, and the like.

The 5G network may transmit an Uplink (UL) grant for scheduling transmission of specific information to the autonomous vehicle 1000 (UL grant receiving step, S22).

The procedure by which the vehicle 1000 receives the UL grant includes a scheduling process in which a time/frequency resource is allocated for transmission of UL data to the 5G network.

The autonomous vehicle 1000 may transmit specific information over the 5G network based on the UL grant (specific information transmission step, S23).

The 5G network may determine whether the vehicle 1000 is to be remotely controlled based on the specific information transmitted from the vehicle 1000 (vehicle remote control determination step, S24).

The autonomous vehicle 1000 may receive the DL grant through a physical DL control channel for receiving a response on pre-transmitted specific information from the 5G network (DL grant receiving step, S25).

The 5G network may transmit information (or a signal) related to the remote control to the autonomous vehicle 1000 based on the DL grant (remote control related information transmission step, S26).

A process in which the initial access process and/or the random access process between the 5G network and the autonomous vehicle 1000 is combined with the DL grant receiving process has been exemplified. However, the present disclosure is not limited thereto.

For example, an initial access procedure and/or a random access procedure may be performed through an initial access step, an UL grant reception step, a specific information transmission step, a remote control decision step of the vehicle, and an information transmission step associated with remote control. Further, an initial access procedure and/or a random access procedure may be performed through a random access step, an UL grant reception step, a specific information transmission step, a remote control decision step of the vehicle, and an information transmission step associated with remote control. The autonomous vehicle 1000 may be controlled by the combination of an AI operation and the DL grant receiving process through the specific information transmission step, the vehicle remote control determination step, the DL grant receiving step, and the remote control related information transmission step.

The operation of the autonomous vehicle 1000 described above is merely exemplary, but the present disclosure is not limited thereto.

For example, the operation of the autonomous vehicle 1000 may be performed by selectively combining the initial access step, the random access step, the UL grant receiving step, or the DL grant receiving step with the specific information transmission step, or the remote control related information transmission step. The operation of the autonomous vehicle 1000 may include the random access step, the UL grant receiving step, the specific information transmission step, and the remote control related information transmission step. The operation of the autonomous vehicle 1000 may include the initial access step, the random access step, the specific information transmission step, and the remote control related information transmission step. The operation of the autonomous vehicle 1000 may include the UL grant receiving step, the specific information transmission step, the DL grant receiving step, and the remote control related information transmission step.

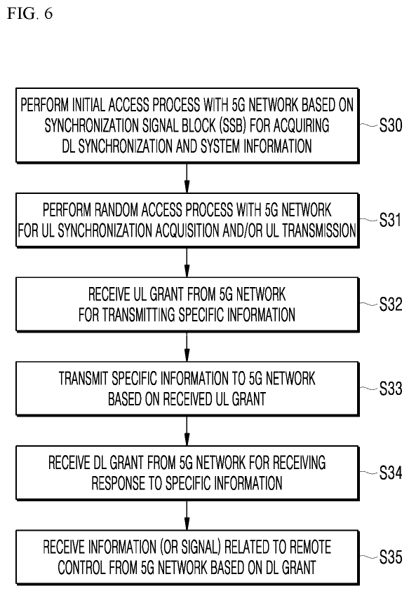

As illustrated in FIG. 6, the vehicle 1000 including an autonomous driving module may perform an initial access process with the 5G network based on Synchronization Signal Block (SSB) for acquiring DL synchronization and system information (initial access step, S30).

The autonomous vehicle 1000 may perform a random access process with the 5G network for UL synchronization acquisition and/or UL transmission (random access step, S31).

The autonomous vehicle 1000 may receive the UL grant from the 5G network for transmitting specific information (UL grant receiving step, S32).

The autonomous vehicle 1000 may transmit the specific information to the 5G network based on the UL grant (specific information transmission step, S33).

The autonomous vehicle 1000 may receive the DL grant from the 5G network for receiving a response to the specific information (DL grant receiving step, S34).

The autonomous vehicle 1000 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

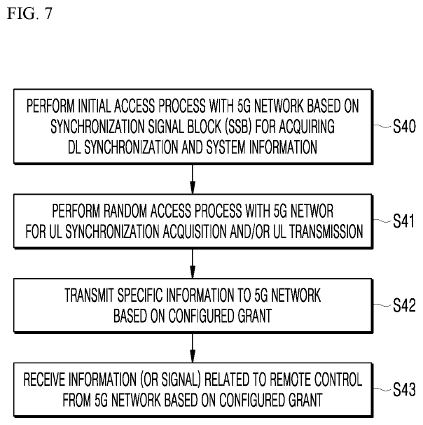

As illustrated in FIG. 7, the autonomous vehicle 1000 may perform an initial access process with the 5G network based on SSB for acquiring DL synchronization and system information (initial access step, S40).

The autonomous vehicle 1000 may perform a random access process with the 5G network for UL synchronization acquisition and/or UL transmission (random access step, S41).

The autonomous vehicle 1000 may transmit specific information based on a configured grant to the 5G network (UL grant receiving step, S42). In other words, instead of receiving the UL grant from the 5G network, the configured grant may be received.

The autonomous vehicle 1000 may receive the remote control related information (or a signal) from the 5G network based on the configured grant (remote control related information receiving step, S43).

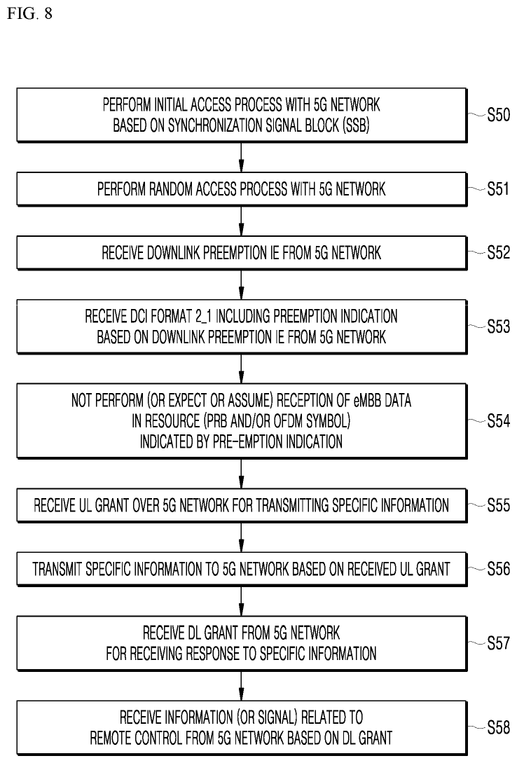

As illustrated in FIG. 8, the autonomous vehicle 1000 may perform an initial access process with the 5G network based on SSB for acquiring DL synchronization and system information (initial access step, S50).

The autonomous vehicle 1000 may perform a random access process with the 5G network for UL synchronization acquisition and/or UL transmission (random access step, S51).

In addition, the autonomous vehicle 1000 may receive Downlink Preemption (DL) and Information Element (IE) from the 5G network (DL Preemption IE reception step, S52).

The autonomous vehicle 1000 may receive DCI (Downlink Control Information) format 2_1 including preemption indication based on the DL preemption IE from the 5G network (DCI format 2_1 receiving step, S53).

The autonomous vehicle 1000 may not perform (or expect or assume) the reception of eMBB data in the resource (PRB and/or OFDM symbol) indicated by the pre-emption indication (step of not receiving eMBB data, S54).

The autonomous vehicle 1000 may receive the UL grant over the 5G network for transmitting specific information (UL grant receiving step, S55).

The autonomous vehicle 1000 may transmit the specific information to the 5G network based on the UL grant (specific information transmission step, S56).

The autonomous vehicle 1000 may receive the DL grant from the 5G network for receiving a response to the specific information (DL grant receiving step, S57).

The autonomous vehicle 1000 may receive the remote control related information (or signal) from the 5G network based on the DL grant (remote control related information receiving step, S58).

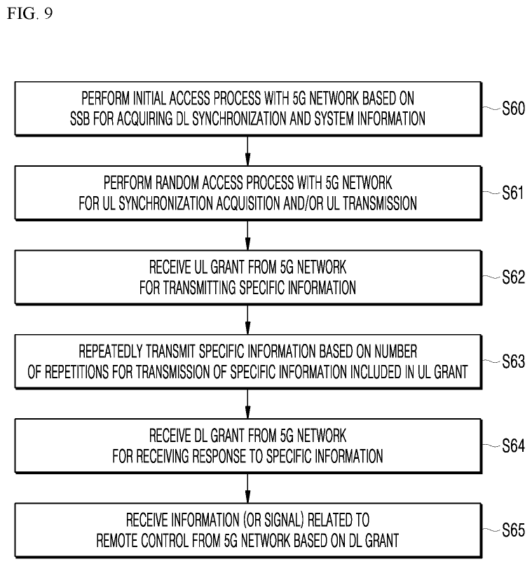

As illustrated in FIG. 9, the autonomous vehicle 1000 may perform an initial access process with the 5G network based on SSB for acquiring DL synchronization and system information (initial access step, S60).

The autonomous vehicle 1000 may perform a random access process with the 5G network for UL synchronization acquisition and/or UL transmission (random access step, S61).

The autonomous vehicle 1000 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous vehicle 1000 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6RB) and Resource Block (1RB).

The autonomous vehicle 1000 may receive the DL grant from the 5G network for receiving a response to the specific information (DL grant receiving step, S64).

The autonomous vehicle 1000 may receive the remote control related information (or signal) from the 5G network based on the DL grant (remote control related information receiving step, S65).

The above-described 5G communication technique can be applied in combination with the embodiment proposed in this specification, which will be described in FIG. 1 to FIG. 17, or supplemented to specify or clarify the technical feature of the embodiment proposed in this specification.

The vehicle 1000 may be connected to an external server through a communication network, and may be capable of moving along a predetermined route without a driver's intervention by using an autonomous driving technique. In the present embodiment, the user may be interpreted as a driver, a passenger, or an owner of a smartphone (user terminal).

The vehicle user interface 1300 may allow interaction between the vehicle 1000 and a vehicle user, receive an input signal of the user, transmit the received input signal to the vehicle controller 1200, and provide information included in the vehicle 1000 to the user under the control of the vehicle controller 1200. The vehicle user interface 1300 may include, but is not limited to, an input module, an internal camera, a bio-sensing module, and an output module.

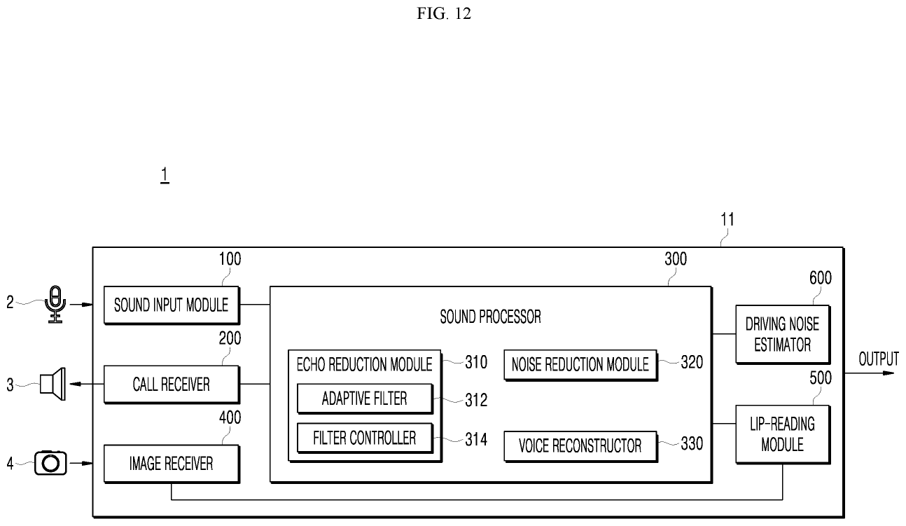

The input module is for receiving information from a user. The data collected by the input module may be analyzed by the vehicle controller 1200 and processed by the user's control command. The input module may receive the destination of the vehicle 1000 from the user and provide the destination to the controller 1200. The input module may input to the vehicle controller 1200 a signal for designating and deactivating at least one of the plurality of sensor modules of the sensor 1700 according to the user's input. The input module may be disposed inside the vehicle. For example, the input module may be disposed on one area of a steering wheel, one area of an instrument panel, one area of a seat, one area of each pillar, one area of a door, one area of a center console, one area of a head lining, one area of a sun visor, one area of a windshield, or one area of a window. In the present embodiment, the input module may include a microphone (2 of FIG. 12) that collects sound signals in the vehicle when the call is connected via the smartphone 2000 connected to the vehicle 1000, and a camera (4 of FIG. 12) that photographs the interior of the vehicle, especially the face of the near-end speaker. The locations and implementation methods of the microphone and the camera are not limited.

The output module is for generating an output related to visual, auditory, or tactile information. The output module may output a sound or an image. Furthermore, the output module may include at least one of a display module, a sound output module, and a haptic output module.

The display module may display graphic objects corresponding to various information. The display module may including at least one of a liquid crystal display (LCD), a thin film transistor liquid crystal display (TFT LCD), an organic light emitting diode (OLED), a flexible display, a 3D display, or an e-ink display. The display module may have a mutual layer structure with a touch input module, or may be integrally formed to implement a touch screen. The display module may be implemented as a head up display (HUD). When the display module is implemented as an HUD, the display module may include a projection module to output information through an image projected onto a windshield or a window. The display module may include a transparent display. The transparent display may be attached to the windshield or the window. The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted. The vehicle user interface 1300 may include a plurality of display modules. The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electrical signal provided from the vehicle controller 1200 into an audio signal. To this end, the sound output module may include one or more speakers. In particular, in the present embodiment, the sound output module may include a speaker (3 of FIG. 12) that outputs a voice signal from the far-end speaker when the call is connected via the smartphone 2000 connected to the vehicle 1000. However, the location and implementation method of the speaker are not limited.

The haptic output module may generate a tactile output. For example, the haptic output module may operate to allow the user to perceive the output by vibrating a steering wheel, a seat belt, and a seat.

The driving controller 1400 may receive a user input for driving. In the case of the manual mode, the vehicle 1000 may operate based on the signal provided by the driving controller 1400. That is, the driving controller 1400 may receive an input for the operation of the vehicle 1000 in the manual mode, and may include a steering input module, an acceleration input module, and a brake input module, but the present disclosure is not limited thereto.

The vehicle driver 1500 may electrically control the driving of various devices in the vehicle 1000, and may include a powertrain driving module, a chassis driving module, a door/window driving module, a safety device driving module, a lamp driving module, and an air conditioning driving module, but the present disclosure is not limited thereto.

The operator 1600 may control various operations of the vehicle 1000, and in particular, may control various operations of the vehicle 1000 in the autonomous driving mode. The operator 1600 may include a driving module, an unparking module, and a parking module, but the present disclosure is not limited thereto. The operator 1600 may include a processor under the control of the vehicle controller 1200. Each module of the operator 1600 may include a processor individually. Depending on the embodiment, when the operator 1600 is implemented as software, it may be a sub-concept of the vehicle controller 1200.

The driving module may perform driving of the vehicle 1000. The driving module may receive object information from the sensor 1700, and provide a control signal to the vehicle driving module to perform the driving of the vehicle 1000. The driving module may receive a signal from an external device through the vehicle communicator 1100, and provide a control signal to the vehicle driving module, so that the driving of the vehicle 1000 may be performed. The unparking module may perform unparking of the vehicle 1000. The unparking module may receive navigation information from the navigation module, and provide a control signal to the vehicle driving module to perform the departure of the vehicle 1000. The unparking module may receive object information from the sensor 1700 and provide a control signal to the vehicle driving module so as to perform the unparking of the vehicle 1000. The unparking module may receive a signal from an external device via the 1100, and provide a control signal to the vehicle driving module to perform the unparking of the vehicle 1000. The parking module may perform parking of the vehicle 1000. The parking module may receive navigation information from the navigation module, and provide a control signal to the vehicle driving module to perform the parking of the vehicle 1000. The parking module may receive object information from the sensor 1700, and provide a control signal to the vehicle driving module so as to perform the parking of the vehicle 1000. The parking module may receive a signal from an external device via the vehicle communicator 1100, and provide a control signal to the vehicle driving module so as to perform the parking of the vehicle 1000. The navigation module may provide the navigation information to the vehicle controller 1200. The navigation information may include at least one of map information, set destination information, route information according to destination setting, information about various objects on the route, lane information, or current location information of the vehicle. The navigation module may provide the vehicle controller 1200 with a parking lot map of the parking lot entered by the vehicle 1000. When the vehicle 1000 enters the parking lot, the vehicle controller 1200 receives the parking lot map from the navigation module, and projects the calculated route and fixed identification information on the provided parking lot map so as to generate the map data. The navigation module may include a memory. The memory may store navigation information. The navigation information may be updated by information received through the vehicle communicator 1100. The navigation module may be controlled by an internal processor, or may operate by receiving an external signal, for example, a control signal from the vehicle controller 1200, but the present disclosure is not limited thereto. The driving module of the operator 1600 may be provided with the navigation information from the navigation module, and may provide a control signal to the vehicle driving module so that driving of the vehicle 1000 may be performed.

The sensor 1700 may sense the state of the vehicle 1000 using a sensor mounted on the vehicle 1000, that is, a signal related to the state of the vehicle 1000, and obtain movement route information of the vehicle 1000 according to the sensed signal. The sensor 1700 may provide the obtained movement route information to the vehicle controller 1200. The sensor 1700 may sense objects near the vehicle 1000 by using a sensor mounted on the vehicle 1000.

The sensor 1700 is for detecting an object located outside the vehicle 1000. The sensor 1700 may generate object information based on the sensing data, and transmit the generated object information to the vehicle controller 1200. Examples of the object may include various objects related to the driving of the vehicle 1000, such as a lane, another vehicle, a pedestrian, a motorcycle, a traffic signal, light, a road, a structure, a speed bump, a landmark, and an animal. The sensor 1700 may be a plurality of sensor modules, and may include a camera module, a lidar (light imaging detection and ranging), an ultrasonic sensor, a radar (radio detection and ranging), and an infrared sensor as a plurality of image capturers.

The sensor 1700 may sense environment information around the vehicle 1000 through a plurality of sensor modules. Depending on the embodiment, the sensor 1700 may further include other components in addition to the above-mentioned components, or may not include some of the above-mentioned components. The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method. The radar may detect an object based on a time-of-flight (TOF) method or a phase-shift method using an electromagnetic wave as a medium, and detect the location of the detected object, the distance to the detected object, and the relative speed of the detected object. The radar may be disposed at an appropriate location outside the vehicle for sensing an object disposed at the front, back, or side of the vehicle.

The lidar may include a laser transmitting module, and a laser receiving module. The lidar may be embodied using the time of flight (TOF) method or in the phase-shift method. The lidar may be implemented as a driven type or a non-driven type. When implemented as a driven type, the lidar may be rotated by a motor, and detect objects near the vehicle 1000. When implemented as a non-driven type, the lidar may detect objects within a predetermined range with respect to the vehicle 1000 by means of light steering. The vehicle 1000 may include a plurality of non-driven type lidars. The lidar may detect an object using the time of flight (TOF) method or the phase-shift method using laser light as a medium, and detect the location of the detected object, the distance from the detected object and the relative speed of the detected object. The lidar may be disposed at an appropriate location outside the vehicle for sensing an object disposed at the front, back, or side of the vehicle.

The image capturer may be disposed at a suitable place outside the vehicle, for example, the front, back, right side mirrors and the left side mirror of the vehicle, in order to acquire a vehicle exterior image. The image capturer may be a mono camera, but is not limited thereto. The image capturer may be a stereo camera, an around view monitoring (AVM) camera, or a 360-degree camera. The image capturer may be disposed close to the front windshield in the interior of the vehicle in order to acquire an image of the front of the vehicle. The image capturer may be disposed around the front bumper or the radiator grill. The image capturer may be disposed close to the rear glass in the interior of the vehicle in order to acquire an image of the back of the vehicle. The image capturer may be disposed around the rear bumper, the trunk, or the tail gate. The image capturer may be disposed close to at least one of the side windows in the interior of the vehicle in order to acquire an image of the side of the vehicle. In addition, the image capturer may be disposed around the fender or the door.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object. The ultrasonic sensor may be disposed at an appropriate location outside the vehicle for sensing an object at the front, back, or side of the vehicle 1000. The infrared sensor may include an infrared transmission module and an infrared reception module. The infrared sensor may detect an object based on infrared light, and detect the position of the detected object, the distance from the detected object, and the relative speed of the detected object. The infrared sensor may be disposed at an appropriate location outside the vehicle 1000 for sensing objects located at the front, back, or side of the vehicle 1000.

The vehicle controller 1200 may control the overall operation of each module of the sensor 1700. The vehicle controller 1200 may compare data sensed by the radar, the lidar, the ultrasonic sensor, and the infrared sensor with pre-stored data so as to detect or classify an object. The vehicle controller 1200 may detect and track the object based on the obtained image. The vehicle controller 1200 may perform operations such as calculation of the distance from an object and calculation of the relative speed of the object through image processing algorithms. For example, the vehicle controller 1200 may obtain the distance information from the object and the relative speed information of the object from the obtained image based on the change of size of the object over time. For example, the vehicle controller 1200 may obtain the distance information from the object and the relative speed information of the object through, for example, a pin hole model and road surface profiling. The vehicle controller 1200 may detect and track the object based on the reflected electromagnetic wave reflected back from the object. The vehicle controller 1200 may perform operations such as calculation of the distance to the object and calculation of the relative speed of the object based on the electromagnetic waves.

The vehicle controller 1200 may detect and track the object based on the reflected laser light reflected back from the object. Based on the laser light, the vehicle controller 1200 may perform operations such as calculation of the distance to the object and calculation of the relative speed of the object based on the laser light. The vehicle controller 1200 may detect and track the object based on the reflected ultrasonic wave reflected back from the object. The vehicle controller 1200 may perform operations such as calculation of the distance to the object and calculation of the relative speed of the object based on the ultrasonic wave. The vehicle controller 1200 may detect and track the object based on the reflected infrared light reflected back from the object. The vehicle controller 1200 may perform operations such as calculation of the distance to the object and calculation of the relative speed of the object based on the infrared light. Depending on the embodiment, the sensor 1700 may include a processor separate from the vehicle controller 1200. In addition, the radar, the lidar, the ultrasonic sensor, and the infrared sensor may each include a processor. When the sensor 1700 includes a processor, the sensor 1700 may be operated under the control of the processor under the control of the vehicle controller 1200.

The sensor 1700 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor. The sensor 1700 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal. The sensor 1700 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS). The sensor 1700 may generate vehicle state information based on sensing data. The vehicle state information may be information generated based on data sensed by various sensors included in the inside of the vehicle. Vehicle state information may include, for example, attitude information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, interior temperature information of the vehicle, interior humidity information of the vehicle, pedal position information, or vehicle engine temperature information.

The vehicle storage 1800 may be electrically connected to the vehicle controller 1200. The vehicle storage 1800 may store basic data for each part of the call quality improvement system 1, control data for controlling the operation of each part of the call quality improvement system 1, and input/output data. In the present embodiment, the vehicle storage 1800 may temporarily or permanently store data processed by the vehicle controller 1200. Here, the vehicle storage 1800 may include magnetic storage media or flash storage media, but the present disclosure is not limited thereto. This vehicle storage 1800 may include an internal memory and an external memory, and may include: a volatile memory such as a DRAM, SRAM, or SDRAM; a non-volatile memory such as a one time programmable ROM (OTPROM), PROM, EPROM, EEPROM, mask ROM, flash ROM, NAND flash memory, or NOR flash memory; and a storage device such as an HDD or a flash drive such as an SSD, compact flash (CF) card, SD card, micro-SD card, mini-SD card, Xd card, or a memory stick. The vehicle storage 1800 may store various data for overall operation of the vehicle 1000, such as a program for processing or controlling the vehicle controller 1200, in particular driver propensity information. The vehicle storage 1800 may be integrally formed with the vehicle controller 1200, or implemented as a sub-component of the vehicle controller 1200.

The processor 1900 may collect the sound signal including the voice signal of the near-end speaker, and acquire the image of the face of the near-end speaker including lips. The processor 1900 may extract the voice signal of the near-end speaker from the collected sound signal. In this case, the processor 1900 may filter out the echo component from the collected sound signal based on the signal inputted to the speaker. The processor 1900 may read the lip movement of the near-end speaker based on the image captured by the camera, and generate a signal about the presence or absence of speech of the near-end speaker according to the lip movement of the near-end speaker. Therefore, in the present embodiment, the call quality may be improved by enabling optimal echo cancellation and noise reduction based on the signal about the presence or absence of the speech of the near-end speaker. In the present embodiment, the processor 1900 may be provided outside the vehicle controller 1200 as illustrated in FIG. 3, may be provided inside the vehicle controller 1200, or may be provided inside the AI server 20 of FIG. 1.

The vehicle controller 1200 may perform the overall control of the vehicle 1000. The vehicle controller 1200 may analyze and process information and data inputted, for example, through the vehicle communicator 1100, the vehicle user interface 1300, the driving controller 1400, and the sensor 1700, or may receive the result analyzed and processed by the processor 1900 and control the vehicle driver 1500 and the operator 1600. The vehicle controller 1200 is a type of a central processor, and may control the operation of the entire vehicle driving controller by driving the control software mounted in the vehicle storage 1800.

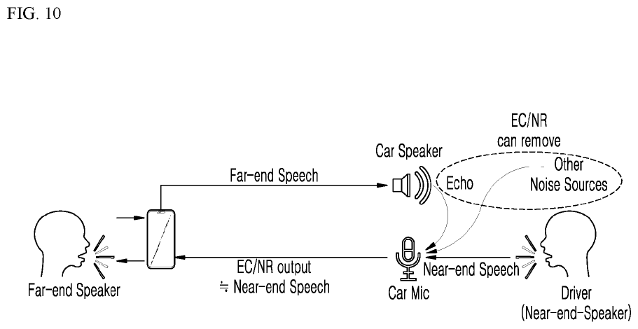

FIG. 10 is an exemplary view for describing a call quality improvement system according to an embodiment of the present disclosure. In the following description, description of parts that are the same as those in FIG. 1 to FIG. 9 will be omitted.

Referring to FIG. 10, in the present embodiment, the vehicle controller 1200 may connect the vehicle 1000 and the smartphone 2000 of the near-end speaker, for example, the driver, through the vehicle communicator 1100, and output far-end speech outputted from the smartphone 2000a of the far-end speaker through the sound output module of the vehicle user interface 1300, for example, the car speaker, when the call is connected to the smartphone 2000a of the far-end speaker. The vehicle controller 1200 may collect a sound signal (near-end speech, echo, and other noise sources) including near-end speech of the near-end speaker through the microphone (car microphone) of the vehicle user interface 1300. In this case, the vehicle controller 1200 may reduce echo by filtering the echo component from the sound signal collected through the microphone based on the signal inputted from the speaker of the vehicle user interface 1300. The vehicle controller 1200 may acquire lip movement information by photographing a face of the near-end speaker through the input module (for example, the camera) of the vehicle user interface 1300. The vehicle controller 1200 may output, to the smartphone 2000a of the far-end speaker, the speech (EC/NR output □ near-end speech) of which the quality is improved through the process of reconstructing the voice signal of the near-end speaker damaged during noise reduction and noise reduction processing based on the lip movement information of the near-end speaker. Herein, the vehicle controller 1200 may include all kinds of devices capable of processing data, such as a processor. Here, the term “processor” may refer to a data processing device built in hardware, which includes physically structured circuits in order to perform functions represented as a code or command present in a program. Examples of the data processing device built in hardware may include microprocessors, central processing units (CPUs), processor cores, multiprocessors, application-specific integrated circuits (ASICs), digital signal processors (DSPs), digital signal processing devices (DSPDs), programmable logic devices (PLDs), processors, controllers, micro-controllers, and field programmable gate array (FPGA), but the present disclosure is not limited thereto.

In the present embodiment, the vehicle controller 1200 may perform machine learning, such as deep learning, with respect to near-end speaker voice signal extraction (echo component filtering, noise reduction) of the call quality improvement system 1, extraction of the presence or absence of the speech of the near-end speaker based on lip movement information of the near-end speaker, reconstruction of the voice signal of the near-end speaker, estimation of noise generated in the vehicle during the vehicle driving according to the model of the vehicle, voice command acquisition, and the user-customized operation and the operation of the call quality improvement system 1 corresponding to the voice command. The vehicle storage 1800 may store data used for machine learning, result data, and the like.

Deep learning, which is a subfield of machine learning, enables data-based learning through multiple layers. Deep learning may represent a set of machine learning algorithms that extract core data from a plurality of data sets as the number of layers increases.

Deep learning structures may include an artificial neural network (ANN). For example, the deep learning structure may include a deep neural network (DNN), such as a convolutional neural network (CNN), a recurrent neural network (RNN), and a deep belief network (DBN). In the present embodiment, the deep learning structure may use a variety of structures well known to those skilled in the art. For example, the deep learning structure according to the present disclosure may include a CNN, a RNN, and a DBN. The RNN is widely used in natural language processing, and can be effectively used to process time-series data that changes over time, and may construct an ANN structure by progressively extracting higher level features through multiple layers. The DBN may include a deep learning structure that is constructed by stacking the result of restricted Boltzman machine (RBM) learning in multiple layers. When a predetermined number of layers are constructed by repetition of such RBM learning, the DBN provided with the predetermined number of layers can be constructed. A CNN includes a model mimicking a human brain function, built under the assumption that when a person recognizes an object, the brain extracts the most basic features of the object and recognizes the object based on the results of complex processing in the brain.

Further, the artificial neural network may be trained by adjusting weights of connections between nodes (if necessary, adjusting bias values as well) so as to produce a desired output from a given input. Furthermore, the artificial neural network may continuously update the weight values through training. Furthermore, a method of back propagation or the like may be used in the learning of the artificial neural network.

That is, an artificial neural network may be installed in the vehicle driving control device, and the vehicle controller 1200 may include an artificial neural network, for example, a deep neural network (DNN) such as CNN, RNN, DBN, or the like. Therefore, the vehicle controller 1200 may train the deep neural network for near-end speaker voice signal extraction (echo component filtering, noise reduction), extraction of the presence or absence of the speech of the near-end speaker based on lip movement information of the near-end speaker, reconstruction of the voice signal of the near-end speaker, estimation of noise generated in the vehicle during the vehicle driving according to the model of the vehicle, voice command acquisition, and the user-customized operation and the operation of the call quality improvement system 1 corresponding to the voice command. Machine learning of the artificial neural network may include unsupervised learning and supervised learning. The vehicle controller 1200 may perform a control to update an artificial neural network structure after learning according to a setting.

In this embodiment, parameters for pre-trained deep neural network may be collected. In this case, the parameters for deep neural network learning may include data such as the sound signal data collected from the microphone, the lip movement information data of the near-end speaker, the voice signal data of the near-end speaker, the signal data inputted from the speaker, the adaptive filter control data, and the noise information data according to the vehicle model. The parameters may also include voice commands, the operation of the call quality improvement system corresponding to the voice commands, and the user-customized operation data. However, in the present embodiment, the parameters for deep neural network learning are not limited thereto. In the present embodiment, data used by an actual user may be collected in order to refine the learning model. That is, in the present embodiment, the user data may be inputted from the user through the vehicle communicator 1100 and the vehicle user interface 1300. In the present embodiment, when the user data is received from the user, input data may be stored in the server and/or the memory regardless of the result of the learning model. That is, in the present embodiment, the call quality improvement system may construct big data by storing data generated when using the hands-free function in the vehicle, and may execute deep learning at the server side to update related parameters in the call quality improvement system, thereby achieving gradual refinement. However, in the present embodiment, the update may be performed by executing deep learning at the call quality improvement system or the edge side of the vehicle by itself. That is, in the present embodiment, deep learning parameters of the laboratory conditions are embedded at the time of initial setting of the call quality improvement system or initial release of the vehicle, and the update may be performed through data accumulated as the user drives the vehicle, that is, as the user uses the hands-free function in the vehicle. Therefore, in the present embodiment, the collected data may be labeled to obtain a result through map learning, and the result may be stored in the memory of the call quality improvement system to complete an evolving algorithm. That is, the call quality improvement system may collect data for improving call quality to generate a training data set, and may train the training data set through a machine learning algorithm to determine a trained model. In addition, the call quality improvement system may collect data used by the actual user and relearn the data in the server to generate a retrained model. Therefore, in the present embodiment, even after data is determined as a learned model, data may be continuously collected and learned by applying a machine learning model, and the performance may be improved by the learned model.

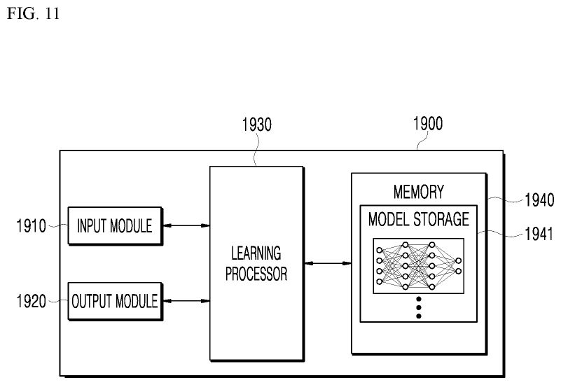

FIG. 11 is a schematic block diagram for describing a learning method of a call quality improvement system according to an embodiment of the present disclosure. In the following description, description of parts that are the same as those in FIG. 1 to FIG. 10 will be omitted.

Referring to FIG. 11, in the present embodiment, the processor 1900 may perform learning. The processor 1900 may include an input module 1910, an output module 1920, a learning processor 1930, and a memory 1940. The processor 1900 may refer to an apparatus, a system, or a server that trains an artificial neural network using a machine learning algorithm or uses a trained artificial neural network. Here, the processor 1900 may include a plurality of servers to perform distributed processing, or may be defined as a 5G network. In this case, the processor 1900 may be included as a partial configuration of the call quality improvement system, and may perform at least part of AI processing together.

The input module 1910 may receive, as input data, the sound signal data collected from the microphone, the lip movement information data of the near-end speaker, the voice signal data of the near-end speaker, the signal data inputted from the speaker, the adaptive filter control data, and the noise information data according to the vehicle model.

The learning processor 1930 may apply the received input data to the learning model for extracting control data for improving call quality. Learning model may include, for example, a neural network model for lip-reading pre-trained to estimate the presence or absence of speech of a person and a voice signal based on the speech according to a change in the positions of the feature points of the person's lips, a neural network model for noise estimation pre-trained to estimate noise generated in a vehicle during vehicle driving according to the vehicle model, and the like. The learning processor 1930 may train the artificial neural network using the training data. The learning model may be used in a state of being mounted on the AI server (20 of FIG. 1) of the artificial neural network, or may be used in a state of being mounted on the external device.

The output module 1920 may output, from the learning model, data such as echo cancellation data, noise reduction data, near-end speaker speech reconstruction data, and adaptive filter control data, for improving call quality.

The memory 1940 may include a model storage 1941. The model storage 1941 may store a model (or an artificial neural network) learning or learned via the learning processor 1930. The learning model may be implemented as hardware, software, or a combination of hardware and software. When a portion or the entirety of the learning model is implemented as software, one or more instructions, which constitute the learning model, may be stored in the memory 1940.

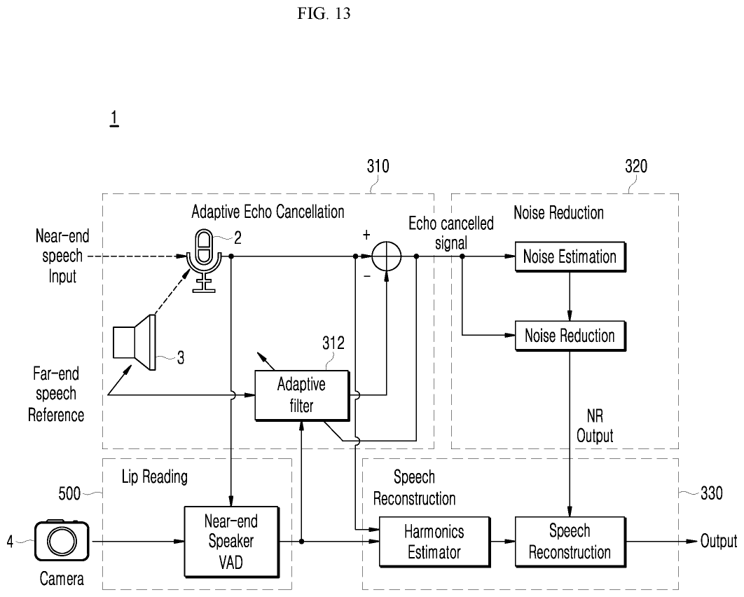

FIG. 12 is a schematic block diagram of a call quality improvement system according to an embodiment of the present disclosure, and FIG. 13 is a block diagram for describing the call quality improvement system in detail according to an embodiment of the present disclosure. In the following description, description of parts that are the same as those in FIG. 1 to FIG. 11 will be omitted.

Referring to FIG. 12, the call quality improvement system 1 may include a microphone 2, a speaker 3, a camera 4, and a call quality improvement apparatus 11.

The present embodiment is directed to improving call quality within a vehicle by performing echo cancellation and noise control in a hands-free call scene within the vehicle. If echo cancellation and noise reduction are not performed properly during the call within the vehicle, echo and in-vehicle noise (driving noise, wind noise, or the like) may be mixed in the voice signal of the driver (near-end speaker), which may cause considerable discomfort to the call partner (far-end speaker). In the present embodiment, echo cancellation and noise reduction are performed by applying the lip-reading technique through the camera 4, thereby improving call quality.

The microphone 2 may collect the sound signal including the voice signal of the near-end speaker, and the speaker 3 may output the voice signal from the far-end speaker. The camera 4 may photograph the face of the near-end speaker, including the lips. The microphone 2, the speaker 3, and the camera 4 may be implemented as the existing devices provided in the vehicle 1000. The locations of the microphone 2, the speaker 3, and the camera 4 are not limited. The microphone 2 and the speaker 3 may be provided at the driver's seat side, and the camera 4 may be provided at a location where it is easy to photograph the driver's face. In the present embodiment, the sound signal including the voice signal of the near-end speaker may be collected through the microphone module mounted on the smartphone 2000 of the near-end speaker. The voice signal from the far-end speaker may be outputted through the speaker module. The face of the near-end speaker may be photographed by the camera module.

More specifically, the call quality improvement apparatus 11 may include a sound input module 100, a call receiver 200, a sound processor 300, an image receiver 400, a lip-reading module 500, and a driving noise estimator 600.

The sound input module 100 may receive the sound signal including the voice signal from the near-end speaker which is collected through the microphone 2.

The call receiver 200 may receive the voice signal from the far-end speaker outputted through the speaker 3.

The sound processor 300 may extract the voice signal of the near-end speaker from the sound signal received through the sound input module 100. The sound processor 300 may include an echo reduction module 310 including an adaptive filter 312 for filtering out an echo component from the sound signal received through the sound input module 100 based on the voice signal received by the call receiver 200, and a filter controller 314 for controlling the adaptive filter 312.

Here, the filter controller 314 may change the parameters of the adaptive filter 312 based on the lip movement information of the near-end speaker. In this case, the image receiver 400 may receive an image of the face of the near-end speaker, including the lips, photographed by the camera 4. That is, the filter controller 314 may change the parameters of the adaptive filter 312 according to the presence or absence of speech of the near-end speaker and the far-end speaker, based on the lip movement information of the near-end speaker extracted from the image of the face of the near-end speaker.

More specifically, referring to FIG. 13, the echo reduction module 310 of the sound processor 300 may cancel the echo from the sound signal collected by the microphone 2 within the vehicle through the adaptive filter 312 (adaptive echo cancellation) by using the far-end speech signal before being outputted to the speaker 3 as the reference signal x. That is, the sound processor 300 may allow the filter controller 314 to change the parameters of the adaptive filter 312 in order to filter out the echo component from the sound signal (near-end speech input) collected through the microphone 2 based on the signal (far-end speech reference) inputted to the speaker 3. In this case, the learning method (ŵ) of the adaptive filter 312 is as follows:

$$\hat{w} ( n + 1 ) = \hat{w} ( n ) + μ {e}^{*} ( n ) \frac{x ( n )}{{x}^{H} ( n ) x ( n )}$$

$$\frac{x ( n )}{{x}^{H} ( n ) x ( n )}$$

may be the input value of the adaptive filter 312, e*(n) may be the error value (error signal), and μ may be the step size value for adjusting the adaptation speed of the adaptive filter 312. Here, e*(n) may be the error between the estimated echo and the real echo. μ is the variable, and echo cancellation performance may be changed depending on the value of μ.

That is, the setting of the parameters of the adaptive filter 312, that is, the step size value for adjusting the adaptation speed, may greatly affect the echo cancellation performance. That is, the sound processor 300 may enable more effective echo cancellation by controlling the parameters of the adaptive filter 312 differently according to the four cases about the presence or absence of the speech of the near-end speaker and the far-end speaker (the case where only the near-end speaker utters speech, the case where only the far-end speaker utters speech, the case where both the near-end speaker and the far-end speaker utter speech, and the case where both the near-end speaker and the far-end speaker do not utter speech). Even in the technique for cancelling residual echo (residual echo suppression), in addition to the parameters of the adaptive filter 312, cancellation intensity must be applied differently according to the four cases about the presence or absence of speech of the near-end speaker and the far-end speaker. Therefore, it is important to exactly know the presence or absence of speech of the near-end speaker and the far-end speaker. That is, when Adaptive Echo Cancellation (AEC) is performed by mixing double-talk detector (DTD) and voice activity detection (VAD) through speech-to-noise ratio (SNR), the sound processor 300 must exactly know the presence or absence of speech of the near-end speaker and the far-end speaker based on the image information (for example, lip-reading) through the camera 4, as well as the sound signal collected by the microphone 2 (Near-end Speaker VAD).

The sound processor 300 may include a noise reduction module 320 for reducing the noise signal in the sound signal from the echo reduction module 310, and a voice reconstructor 330 for reconstructing the voice signal of the near-end speaker damaged during the noise reduction process through the noise reduction module 320, based on the lip movement information of the near-end speaker. This is for reconstructing the voice signal of the near-end speaker, since wind noise and driving noise may be severe in the real vehicle environment, and the driver's speech may be seriously damaged (speech distortion) when the noise cancellation intensity is increased so as to cancel noise coming into the microphone 2 that is louder than the driver's speech. That is, in the present embodiment, discomfort during the call, which is caused by the damage to the speech, may be solved by determining the noise from the sound signal (echo canceled signal) from the echo reduction module 310, and reconstructing the voice signal (NR output) of the near-end speaker damaged during the noise reduction process.

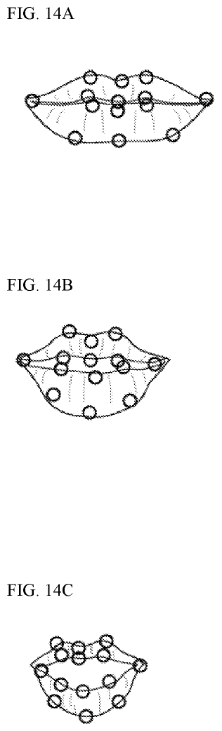

FIGS. 14A to 14C are exemplary views for describing a lip movement reading method of a call quality improvement system according to an embodiment of the present disclosure. In the following description, description of parts that are the same as those in FIG. 1 to FIG. 13 will be omitted.

Referring to FIGS. 14A to 14C, the lip-reading module 500 may perform lip-reading for reading the lip movement of the near-end speaker based on the image captured by the camera 4. As described above, in order to improve call quality, it is important to know the presence or absence of the speech of the near-end speaker. When the presence or absence of the speech of the near-end speaker is detected by estimating the speech-to-noise ratio (SNR) using only the sound signal collected by the microphone 2, the performance is significantly reduced in a situation where noise in the vehicle is dominant. Therefore, in the present embodiment, the presence or absence of the speech of the near-end speaker may be accurately estimated through the image for determining the lip movement of the near-end speaker using the camera 4.

That is, the lip-reading module 500 may generate the signal about the presence or absence of the speech of the near-end speaker by determining that the speech of the near-end speaker exists when the lip movement of the near-end speaker is equal to or greater than a first size as illustrated in FIG. 14C, and determining that the speech of the near-end speaker does not exist when the lip movement of the near-end speaker is less than a second size as illustrated in FIG. 14A. In this case, the second size may be set to a value less than or equal to the first size. When the lip movement of the near-end speaker is less than the first size and greater than or equal to the second size as illustrated in FIG. 14B, the lip-reading module 500 may determine the presence or absence of the speech of the near-end speaker based on the signal-to-noise ratio (SNR) value estimated for the sound signal.

That is, the lip-reading module 500 may detect the lip part in the image (image of the face of the near-end speaker) captured through the camera 4, map feature points of the lips, and initially determine the presence or absence of the speech of the near-end speaker by using the pre-trained model of the locations of the feature points. However, when the lip-reading result is ambiguous as illustrated in FIG. 14B, the presence or absence of the speech of the near-end speaker may be finally determined based on the SNR value estimated for the sound signal. The size of the lip movement may be calculated as the length of the line connecting the center point of the upper lip and the center point of the lower lip, or the average value of the lengths of a plurality of lines connecting specific points of the upper lip and specific points of the lower lip corresponding thereto, but the present disclosure is not limited thereto.

The lip-reading module 500 may estimate the presence or absence of the speech of the near-end speaker and the voice signal according to the speech based on the image captured by the camera 4 by using the neural network model for lip-reading pre-trained to estimate the presence or absence of the speech of the person and the voice signal based on the speech according to the change in the locations of the feature points of the lips of the person.

Based on the signal about the presence or absence of the speech of the near-end speaker from the lip-reading module 500 and the signal inputted from the speaker 3, the filter controller 314 may control the parameter value of the adaptive filter 312 to be a first value when only the near-end speaker utters speech. Based on the signal about the presence or absence of the speech of the near-end speaker from the lip-reading module 500 and the signal inputted from the speaker 3, the filter controller 314 may control the parameter value of the adaptive filter 312 to be a second value when only the far-end speaker utters speech. In addition, based on the signal about the presence or absence of the speech of the near-end speaker from the lip-reading module 500 and the signal inputted from the speaker 3, the filter controller 314 may control the parameter value of the adaptive filter 312 to be a third value when both the near-end speaker and the far-end speaker utter speech, and may control the parameter value of the adaptive filter 312 to be a fourth value when both the near-end speaker and the far-end speaker do not utter speech. In this case, the first to fourth values may be preset.

That is, the sound processor 300 may extract the voice signal of the near-end speaker from the sound signal collected from the microphone 2, based on the presence or absence of the speech of the near-end speaker estimated from the lip-reading module 500 and the voice signal based on the speech.

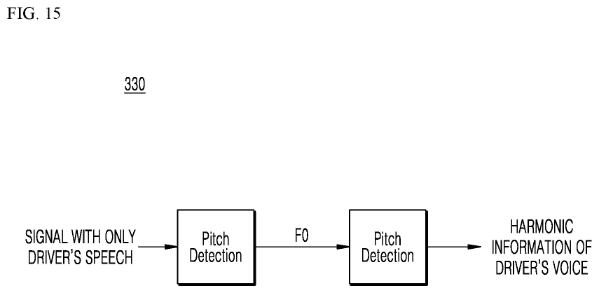

FIG. 15 is a schematic diagram for describing a voice restoration method of a call quality improvement system according to an embodiment of the present disclosure. In the following description, description of parts that are the same as those in FIG. 1 to FIG. 14C will be omitted.

Referring to FIG. 15, the voice reconstructor 330 may extract pitch information of the near-end speaker from the sound signal when only the near-end speaker utters speech, determine the speech features of the near-end speaker based on the pitch information, and reconstruct the voice signal of the near-end speaker damaged during the noise reduction process through the noise reduction module 320, based on the speech features. That is, since the voice reconstructor 330 can exactly know the case where there is only the speech of the near-end speaker through the lip-reading module 500, the voice reconstructor 330 may extract the pitch information of the near-end speaker from the sound signal collected through the microphone 2 (pitch detection). That is, in the present embodiment, since the voice reconstructor 330 can exactly know the pitch information of the near-end speaker, the voice reconstructor 330 may identify the frequency band F0 of voice harmonics of the near-end speaker based on the pitch information of the near-end speaker (harmonic estimation). In this case, the voice reconstructor 330 may reconstruct the damaged voice signal of the near-end speaker by boosting only the frequency band in which harmonics of the near-end speaker are formed in the voice signal damaged due to excessive noise reduction, based on the harmonic information of the near-end speech. In the present embodiment, such a function may be used to implement an equalizer function. Thus, the speech is turned so that the far-end speaker can hear more easily during the call in the vehicle.

The call quality improvement system 1 may be disposed inside the vehicle and may include a driving noise estimator 600 that receives driving information of the vehicle and estimates noise information generated in the vehicle according to a driving operation.

The noise reduction module 320 may reduce the noise signal in the sound signal from the echo reduction module 310 based on the noise information estimated by the driving noise estimator 600.

The driving noise estimator 600 may estimate noise information generated in the vehicle according to the driving operation of the vehicle by using the neural network model for noise estimation pre-trained to estimate noise generated in a vehicle during a vehicle driving operation according to the model of the vehicle.

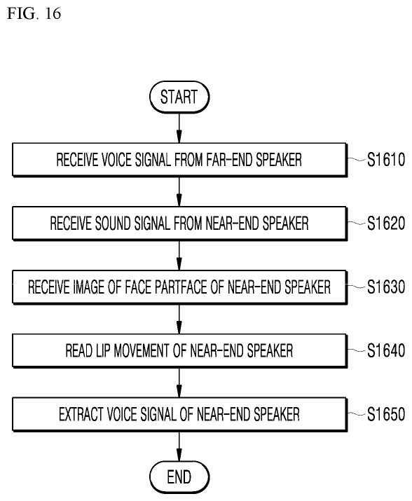

FIG. 16 is a flowchart of a call quality improvement method according to an embodiment of the present disclosure. In the following description, description of parts that are the same as those in FIG. 1 to FIG. 15 will be omitted.

Referring to FIG. 16, in step S1610, the call quality improvement apparatus 11 receives the voice signal from the far-end speaker. That is, the call quality improvement apparatus 11 may receive the voice signal from the far-end speaker outputted through the speaker 3.

In step S1620, the call quality improvement apparatus 11 receives the sound signal from the near-end speaker. That is, the call quality improvement apparatus 11 may receive the sound signal including the voice signal from the near-end speaker which is collected through the microphone 2.

In step S1630, the call quality improvement apparatus 11 receives the image of the face of the near-end speaker. That is, the call quality improvement apparatus 11 may receive the image of the face of the near-end speaker, including the lips photographed through the camera 4.

In step S1640, the call quality improvement apparatus 11 reads the lip movement of the near-end speaker. That is, the call quality improvement apparatus 11 may perform lip-reading to read the lip movement of the near-end speaker based on the image captured by the camera 4. For example, the call quality improvement apparatus 11 may generate the signal about the presence or absence of the speech of the near-end speaker by determining that the speech of the near-end speaker exists when the lip movement of the near-end speaker is equal to or greater than the first size, and determining that the speech of the near-end speaker does not exist when the lip movement of the near-end speaker is less than the second size. In this case, the second size may be set to a value less than or equal to the first size. When the lip movement of the near-end speaker is less than the first size and greater than or equal to the second size, the call quality improvement apparatus 11 may determine the presence or absence of the speech of the near-end speaker based on the signal-to-noise ratio (SNR) value estimated for the sound signal. That is, the call quality improvement apparatus 11 may detect the lip part in the image (image of the face of the near-end speaker) captured through the camera 4, map the feature points of the lips, and initially determine the presence or absence of the speech of the near-end speaker by using the pre-trained model of the locations of the feature points. However, when the lip-reading result is ambiguous, the presence or absence of the speech of the near-end speaker may be finally determined based on the SNR value estimated for the sound signal. The size of the lip movement may be calculated as the length of the line connecting the center point of the upper lip and the center point of the lower lip, or the average value of the lengths of a plurality of lines connecting specific points of the upper lip and specific points of the lower lip corresponding thereto, but the present disclosure is not limited thereto. In the present embodiment, the call quality improvement apparatus 11 may estimate the presence or absence of the speech of the near-end speaker and the voice signal according to the speech based on the image captured by the camera 4 by using the neural network model for lip-reading pre-trained to estimate the presence or absence of the speech of the person and the voice signal based on the speech according to the change in the locations of the feature points of the lips of the person.

In step S1650, the call quality improvement apparatus 11 extracts the voice signal of the near-end speaker. That is, the call quality improvement apparatus 11 may receive the sound signal collected through the microphone 2 and extract the voice signal of the near-end speaker from the sound signal. The call quality improvement apparatus 11 may receive the voice signal outputted to the speaker 3 and filter out the echo component from the sound signal based on the voice signal. That is, the call quality improvement apparatus 11 may extract the voice signal of the near-end speaker from the sound signal collected from the microphone 2, based on the presence or absence of the speech of the near-end speaker estimated in step 51640 and the voice signal based on the speech.

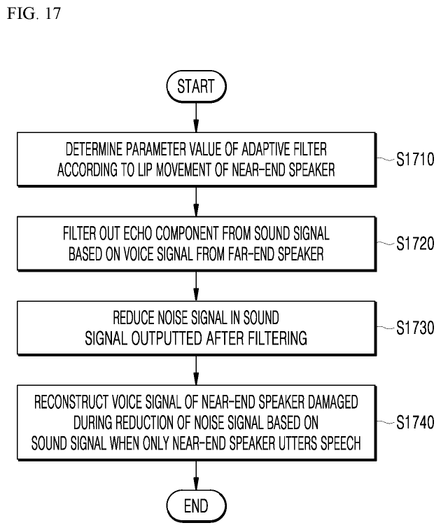

FIG. 17 is a flowchart for describing a voice signal extraction method of a call quality improvement system according to an embodiment of the present disclosure. In the following description, description of parts that are the same as those in FIG. 1 to FIG. 16 will be omitted.

Referring to FIG. 17, in step S1710, the call quality improvement apparatus 11 determines the parameter value of the adaptive filter 312 according to the lip movement of the near-end speaker. That is, the call quality improvement apparatus 11 may change the parameters of the adaptive filter 312 based on the lip movement information of the near-end speaker, and change the parameters of the adaptive filter 312 according to the presence or absence of the speech of the near-end speaker and the far-end speaker, based on the lip movement information of the near-end speaker extracted from the image of the face of the near-end speaker.

In step S1720, the call quality improvement apparatus 11 filters out the echo component from the sound signal based on the voice signal from the far-end speaker. That is, based on the signal about the presence or absence of the speech of the near-end speaker through the lip-reading and the signal inputted from the speaker 3, the call quality improvement apparatus 11 may control a parameter value of the adaptive filter 312 to be the first value when only the near-end speaker utters speech. Based on the signal about the presence or absence of the speech of the near-end speaker through the lip-reading and the signal inputted from the speaker 3, the call quality improvement apparatus 11 may control a parameter value of the adaptive filter 312 to be the second value when only the far-end speaker utters speech. In addition, based on the signal about the presence or absence of the speech of the near-end speaker through the lip-reading and the signal inputted from the speaker 3, the call quality improvement apparatus 11 may control the parameter value of the adaptive filter 312 to be the third value when both the near-end speaker and the far-end speaker utter speech, and may control the parameter value of the adaptive filter 312 to be the fourth value when both the near-end speaker and the far-end speaker do not utter speech. That is, the call quality improvement apparatus 11 may allow the filter controller 314 to change the parameters of the adaptive filter 312 in order to filter out the echo component from the sound signal (near-end speech input) collected through the microphone 2 based on the signal (far-end speech reference) inputted to the speaker 3. Therefore, the call quality improvement apparatus 11 may cancel the echo from the sound signal collected by the microphone 2 within the vehicle through the adaptive filter 312 (adaptive echo cancellation) by using the far-end speech signal before being outputted to the speaker 3 as the reference signal x.

In step S1730, the call quality improvement apparatus 11 reduces the noise signal in the sound signal outputted after filtering. That is, the call quality improvement apparatus 11 may confirm the presence or absence of the speech of the near-end speaker and/or the far-end speaker based on the signal about the presence or absence of the speech of the near-end speaker through the lip-reading, and may reduce the noise of the sound which is determined as noise other than the speech of the near-end speaker and/or the far-end speaker. According to the present embodiment, driving information of the vehicle may be received, and noise information generated in the vehicle may be estimated according to the driving operation. In this case, the call quality improvement apparatus 11 may reduce the noise signal in the sound signal from the echo reduction module 310 based on the estimated noise information. The call quality improvement apparatus 11 may estimate noise information generated in the vehicle according to the driving operation of the vehicle 1 by using the neural network model for noise estimation pre-trained to estimate noise generated in a vehicle during the vehicle driving operation according to the model of the vehicle.

In step S1740, the call quality improvement apparatus 11 reconstructs the voice signal of the near-end speaker damaged during the reduction of the noise signal based on the sound signal when only the near-end speaker utters speech. This is for reconstructing the voice signal of the near-end speaker, since wind noise and driving noise may be severe in the real vehicle environment, and the driver's speech may be seriously damaged (speech distortion) when the noise cancellation intensity is increased so as to cancel noise coming into the microphone 2 that is louder than the driver's speech. That is, the call quality improvement apparatus 11 may solve discomfort during the call, which is caused by the damage to the speech, by determining the noise from the sound signal (echo canceled signal) and reconstructing the voice signal (NR output) of the near-end speaker damaged during the noise reduction process. In this case, the call quality improvement apparatus 11 may extract pitch information of the near-end speaker from the sound signal when only the near-end speaker utters speech, determine the speech features of the near-end speaker based on the pitch information, and reconstruct the voice signal of the near-end speaker damaged during the noise reduction process through the noise reduction module 320, based on the speech features. That is, since the call quality improvement apparatus 11 can exactly know the case where there is only the speech of the near-end speaker through the lip-reading, the call quality improvement apparatus 11 may extract the pitch information of the near-end speaker from the sound signal collected through the microphone 2 (pitch detection). That is, in the present embodiment, since the voice reconstructor 330 can exactly know the pitch information of the near-end speaker, the voice reconstructor 330 may identify the frequency band F0 of voice harmonics of the near-end speaker based on the pitch information of the near-end speaker (harmonic estimation). In this case, the call quality improvement apparatus 11 may reconstruct the damaged voice signal of the near-end speaker by boosting only the frequency band in which harmonics of the near-end speaker are formed in the voice signal damaged due to excessive noise reduction, based on the harmonic information of the near-end speech.

The embodiments of the present disclosure described above may be implemented through computer programs executable through various components on a computer, and such computer programs may be recorded in computer-readable media. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

The computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present application (especially in the appended claims), the terms “a/an” and “the” include both singular and plural references, unless the context clearly conditions otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example”, etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof. It should be apparent to those skilled in the art that various substitutions, changes and modifications which are not exemplified herein but are still within the spirit and scope of the present disclosure may be made.

Also, it should be apparent to those skilled in the art that various alterations, substitutions, and modifications may be made within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. A call quality improvement system using lip-reading, the call quality improvement system comprising:
a microphone configured to collect a sound signal including a voice signal of a near-end speaker;
a speaker configured to output a voice signal from a far-end speaker;
a camera configured to photograph a face of the near-end speaker, including lips; and
a sound processor configured to extract the voice signal of the near-end speaker from the sound signal collected from the microphone,
wherein the sound processor comprises an echo reduction module including an adaptive filter configured to filter out an echo component from the sound signal collected through the microphone based on a signal inputted to the speaker, and a filter controller configured to control the adaptive filter, and
the filter controller changes parameters of the adaptive filter based on lip movement information of the near-end speaker.

2. The call quality improvement system according to claim 1, wherein the sound processor further comprises:
a noise reduction module configured to reduce a noise signal in the sound signal from the echo reduction module; and
a voice reconstructor configured to reconstruct the voice signal of the near-end speaker damaged during a noise reduction process through the noise reduction module, based on the lip movement information of the near-end speaker.

3. The call quality improvement system according to claim 1, further comprising a lip-reading module configured to read a lip movement of the near-end speaker based on an image captured by the camera,
wherein the lip-reading module generates a signal about the presence or absence of speech of the near-end speaker by determining that the speech of the near-end speaker exists when a lip movement of the near-end speaker is equal to or greater than a first size, and determining that the speech of the near-end speaker does not exist when the lip movement of the near-end speaker is less than a second size, and
the second size is a value less than or equal to the first size.

4. The call quality improvement system according to claim 3, wherein when the lip movement of the near-end speaker is less than the first size and greater than or equal to the second size, the lip-reading module determines the presence or absence of the speech of the near-end speaker based on a signal-to-noise ratio (SNR) value estimated for the sound signal.

5. The call quality improvement system according to claim 3, wherein, based on the signal about the presence or absence of the speech of the near-end speaker from the lip-reading module and the signal inputted to the speaker, the filter controller is configured to:
control a parameter value of the adaptive filter to be a first value when only the near-end speaker utters speech,
control the parameter value of the adaptive filter to be a second value when only the far-end speaker utters speech,
control the parameter value of the adaptive filter to be a third value when both the near-end speaker and the far-end speaker utter speech, and
control the parameter value of the adaptive filter to be a fourth value when both the near-end speaker and the far-end speaker do not utter speech.

6. The call quality improvement system according to claim 5, wherein the voice reconstructor extracts pitch information of the near-end speaker from the sound signal when only the near-end speaker utters speech, determines speech features of the near-end speaker based on the pitch information, and reconstructs the voice signal of the near-end speaker damaged during a noise reduction process through the noise reduction module, based on the speech features.

7. The call quality improvement system according to claim 1, further comprising a lip-reading module configured to read a lip movement of the near-end speaker based on an image captured by the camera,
wherein the lip-reading module estimates the presence or absence of the speech of the near-end speaker and the voice signal according to the speech based on the captured image by using a neural network model for lip-reading pre-trained to estimate the presence or absence of speech of a person and a voice signal based on the speech according to a change in locations of feature points of lips of the person.

8. The call quality improvement system according to claim 7, wherein the sound processor extracts the voice signal of the near-end speaker from the sound signal collected from the microphone, based on the presence or absence of the speech of the near-end speaker estimated from the lip-reading module and the voice signal based on the speech.

9. The call quality improvement system according to claim 2, wherein:
the call quality improvement system is disposed in a vehicle,
the call quality improvement system further comprises a driving noise estimator configured to receive driving information of the vehicle and estimate noise information generated in the vehicle according to a driving operation, and the noise reduction module is configured to reduce the noise signal in the sound signal
from the echo reduction module based on the noise information estimated by the driving noise estimator.

10. The call quality improvement system according to claim 9, wherein the driving noise estimator estimates the noise information generated in the vehicle according to the driving operation of the vehicle by using a neural network model for noise estimation pre-trained to estimate noise generated in a vehicle during a vehicle driving operation according to a model of the vehicle.

11. A call quality improvement apparatus using lip-reading, the call quality improvement apparatus comprising:
a call receiver which receives a voice signal from a far-end speaker;
a sound input module which receives a sound signal including a voice signal from a near-end speaker;
an image receiver configured to receive an image of a face of the near-end speaker, including lips; and
a sound processor configured to extract the voice signal of the near-end speaker from the sound signal collected through the sound input module,
wherein the sound processor comprises an adaptive filter configured to filter out an echo component in the sound signal based on the voice signal received by the call receiver, and
parameters of the adaptive filter are changed based on lip movement information of the near-end speaker.

12. The call quality improvement apparatus according to claim 11, wherein the sound processor further comprises:
a noise reduction module configured to reduce a noise signal in the sound signal from the echo reduction module; and
a voice reconstructor configured to reconstruct the voice signal of the near-end speaker damaged during a noise reduction process through the noise reduction module, based on the lip movement information of the near-end speaker.

13. The call quality improvement apparatus according to claim 11, further comprising a lip-reading module configured to read a lip movement of the near-end speaker based on the image received from the image receiver,
wherein the lip-reading module generates a signal about the presence or absence of speech of the near-end speaker by determining that the speech of the near-end speaker exists when a lip movement of the near-end speaker is equal to or greater than a first size, and determining that the speech of the near-end speaker does not exist when the lip movement of the near-end speaker is less than a second size, and
the second size is a value less than or equal to the first size.

14. The call quality improvement apparatus according to claim 13, wherein when the lip movement of the near-end speaker is less than the first size and greater than or equal to the second size, the lip-reading module determines the presence or absence of the speech of the near-end speaker based on a signal-to-noise ratio (SNR) value estimated for the sound signal.

15. The call quality improvement apparatus according to claim 13, wherein the parameters of the adaptive filter are determined based on the signal about the presence or absence of the speech of the near-end speaker from the lip-reading module and the voice signal received by the call receiver.

16. The call quality improvement apparatus according to claim 15, wherein the voice reconstructor determines a case where only the near-end speaker utters speech, based on the signal about the presence or absence of the speech of the near-end speaker from the lip-reading module and the voice signal received by the call receiver, extracts pitch information of the near-end speaker from the sound signal uttered by only the near-end speaker, determines speech features of the near-end speaker based on the pitch information, and reconstructs the voice signal of the near-end speaker damaged in a noise reduction process through the noise reduction module based on the speech features.

17. A call quality improvement method using lip-reading, the call quality improvement method comprising:
receiving a voice signal from a far-end speaker;
receiving a sound signal including a voice signal from a near-end speaker;
receiving an image of a face of the near-end speaker, including lips; and
extracting the voice signal of the near-end speaker from the received sound signal,
wherein the extracting of the voice signal comprises:
determining a parameter value of an adaptive filter according to a lip movement of the near-end speaker; and
filtering out an echo component from the sound signal using the adaptive filter based on the voice signal from the far-end speaker.

18. The call quality improvement method according to claim 17, wherein the extracting of the voice signal comprises:
reducing a noise signal in the sound signal outputted from the filtering; and
reconstructing the voice signal of the near-end speaker damaged in the reducing of the noise signal, based on a sound signal when the far-end speaker does not utter speech and the near-end speaker utters speech.

19. The call quality improvement method according to claim 18, further comprising, after the receiving of the image, reading a lip movement of the near-end speaker based on the received image,
wherein the reading comprises generating a signal about the presence or absence of speech of the near-end speaker by determining that the speech of the near-end speaker exists when the lip movement of the near-end speaker is equal to or greater than a first size, and determining that the speech of the near-end speaker does not exist when the lip movement of the near-end speaker is less than a second size.

20. The call quality improvement method according to claim 19, wherein the reconstructing of the voice signal of the near-end speaker comprises:
extracting pitch information of the near-end speaker from a sound signal when only the near-end speaker utters speech;
determining speech features of the near-end speaker based on the pitch information; and
reconstructing the voice signal of the near-end speaker damaged in the reducing of the noise signal based on the speech features.
